(19) United States
(12) Patent Application Publication
(10) Pub. No.: US 2014/0025394 A1
(43) Pub. Date: Jan. 23, 2014

(54) SYSTEM FOR ASSISTING CONTROL OF RESCUING MEDICAL SERVICES, SERVER, AND MOBILE DEVICE

(71) Applicants: Noriaki Aoki, Tokyo (JP); Sachiko Ohta, Tokyo (JP)

(72) Inventors: Noriaki Aoki, Tokyo (JP); Sachiko Ohta, Tokyo (JP)

(21) Appl. No.: 13/980,877

(22) PCT Filed: Dec. 2, 2011
(86) PCT No.: PCT/JP2011/006758

§ 371 Date: Oct. 10, 2013

(30) Foreign Application Priority Data
Jan. 21, 2011 (JP) 2011-011319

(51) Int. Cl. G06Q 10/06; G06Q 50/22

(52) U.S. Cl. CPC G06Q 10/063114; G06Q 50/22
USPC 705/2

(57) ABSTRACT

A mobile device and server as an integrated emergency information system. The server includes a main control unit; a display control unit producing screen data to control display on the mobile device; a time stamp acquisition unit detecting an event from the mobile device and acquiring a time stamp; an information registration unit receiving information registration; an index production unit producing prescribed indexes based on the registered information and the acquired time stamp; and a unit for determining the degree of emergency and severity of illness or injury based on the registered information and a “performance standard on transportation and acceptance of a sick or injured person” determined by each municipality. The determining unit displays candidates for transportation to a medical institution corresponding to specific diseases, as a list based on the degree of emergency and severity and a list determined by the municipality if a specific disease is anticipated.

### FIELD OF THE INVENTION

This invention relates to a system for assisting control of rescuing medical services, a server, and a mobile device.

Currently, “transportation time by ambulance (time from calling to hospital arrival)” announced by the Fire and Disaster Management Agency, Ministry of Internal Affairs and Communications (MIC) is frequently used as an evaluation index for quality of prehospital emergency medical service (EMS). This index, however, reflects merely an aspect of EMS. EMS can be compared to a baton relay from patient to EMS, EMS to acute care facility, and acute care facility to physicians, and this index is like paying an attention to shorten a lap time of the second runner during the rescuing relay and likely neglects baton passing work between the runners. “Time from occurrence to treatment,” or namely the total time of the relay runners, should be essentially the sole index from a medical viewpoint. To utilize this index, it is required to integrate the time from occurrence to hospital arrival on a side of the emergency medical team and time from hospital arrival to treating start owned by the medical institution, but in fact, no data is integrated at all at this time between the emergency medical information system (prehospital) and the diagnosis record in the medical institution (hospital information system).

As further progressing and specializing of medical care, curable diseases may become different according to “the specialization of the doctor on duty.” For example, even as a surgical doctor, a neurosurgeon may not perform abdominal surgery whereas a special doctor may not perform operation for heart. Accordingly, it is important to achieve “right patient, right place, right time”. It is, however, still customary for emergency medical technicians (EMTs) tend to transfer all patients, regardless urgency, to the nearest acute care facility. In other words, the rescue team may not chose any means other than the transportation to the nearest. The rescue team at the same time does not understand any reason why the team may not do the transportation to the nearest. There is no apparent rule such that “the person should be transported to that medical institution if the disease is of ‘A’ although the institution is ten minutes away.”

To the contrary, under the Japanese Fire and Disaster Management Act revised last year, each prefecture is required to set up a transportation standard rules in accordance with severity and urgency and to produce a list of the transportation destination medical institutions. The list of the transportation destination medical institutions is not determined by standing as a candidate of each medical institution but is essentially set up based on “objective evaluation” on respective medical institutions. Each medical institution therefore is desired to explicit standardized“quality indicators”, which is objective evaluations.

Fire Department (FD) is presently operated by municipality, so that an information system of each fire department is executed independently. For example, in Nara prefecture, there are thirteen fire departments, but the transportation data are not commonly shared in prefectural level. That is, it causes a state such that the active state of the Nara city's fire fighting department is totally unknown to the fire fighting department of Ikoma city though those cities are adjacent to each other.

Discordance between the EMT and the medical institutions also raises a problem. That is, at the medical institution, what is happens is that: the medical institution many times receives inquiries regarding “unacceptable disease and injury”; the medical institution receives an inquiry from one EMT even where being busy due to acceptance of other emergency patients one moment before; and further severely damaged patient is brought where it is said as “slightly injured.” Those are caused from a practice of the transpiration to the nearest as well as from no commonly owned data among respective fire departments, and where those are repeated, the medical institution likely makes a ruling for declining acceptance when having a doubt.

Medical institutions by themselves are also divided. That is, the medical institutions do know a status of their institutions but do not know a status such that: what patient is currently coming to the adjacent hospital; what treatment or operation is conducted; and there is any urgent patient. Accordingly, there are many medical institutions having an idea such that “some other institution may accept this patient” even where the institution decline a request for patient acceptance from the EMT.

In general, a system in which the medical institutions indicate vacancy statuses of the medical institutions' beds and resources with “circle (available)” or “cross (unavailable)” for each medical consultation division or each specialty and in which the EMT judges the transportation destination based on the signs is called as a emergency medical information system. However, a current emergency medical information system is hardly used from reasons such that input is laborious because the location is remote from the emergency room, that it is hard to sweepingly put “circle” and “cross” because in fact the acceptance is totally judged from the status at that time, the status of the patient, etc, and that ultimately a call is inevitably made even where an immediately pervious transportation's status is unavailable. For example, when viewing a transportation example of digestive tract bleeding in a municipality, referring numbers of times are nearly the same between the medical institutions indicating circle and for the medical institutions indicating cross. Furthermore, more than a half of acceptances are not allowed with respect to inquires even where the number of the medical institutions indicating circle (available) on the emergency medical information system is more than the patient number occurring during a day.

In a case where an area includes acute medical facilities in a smaller number, even at facilities at which patients are accepted nearly one hundred percent as to prevent rejection of acceptance from occurring. It is desired to integrate prehospital observation data with data at the acute medical facilities in order to develop accurate list of hospital based on objective performance measures, namely quality of emergency care (quality indicators) provided at the medical institutions listed on the medical institution classification of “transportation performance reference” determined by respective prefectures based on the revised Japanese fire fighting law as well as to do evaluation of accuracy of observation reference and selection reference.

Although FDs, local governments, and medical facilities respectively manage their data independently, those data should be integrated to grasp a status of local emergency care services and emergency healthcare.

In summary, those issues stems from a lack of bird's-eye view of entire emergency medical care from pre-hospital to acute care facilities.

In Patent Document #1, what is disclosed is an emergency medical information system capable of searching the most suitable acute medical facility at a time of a request for emergency medical care from an ambulance where an EMTs always grasp the acceptance status of acute medical facility as emergency transpiration destinations.

### PRIOR ART TECHNICAL DOCUMENTS

### Patent Document

Patent Document #1: Japanese Patent Application Publication No. 2009-187167.

### SUMMARY OF THE INVENTION

### Problems to be Solved by the Invention

When summarizing the above problems, however, a system for assisting control of rescuing medical services is required to realize things as follows:

a) visualization of consulting function, process, and outcome of each medical institution according to quality index;

b) integration of emergency medical information and medical institution information, as well as visualization of consultation teamwork status;

c) visualization of emergency medical services in the entire areas from integration of emergency medical information stored at respective fire fighting headquarters;

d) system of common ownership of information not laborious for busy rescue related persons;

e) assistance for decision making for deciding the proper transportation destination based on severity and emergency degree; and

f) information providing for system evaluation and circulation of the PDSA cycle.

It is an object of the invention, in consideration of the above described technical problems, to provide a system for assisting control of rescuing medical services, a server, and a mobile device, in which reasonable decision can be made by decision making of a rescue team and a medical institutions based on “the same” information, in which the best decision can be made corresponding to the situation by rendering all rescue relating persons know the rescue medical information of the entire prefecture level, thereby resultantly shortening the transpiration time and time “from sick occurrence to treatment start,” improving patient's convalescence, and periodically evaluating properness and reliance of the transportation reference and the hospital list and improving them.

### Means for Solving Problems

To solve the above technical problems, in accordance with a first embodiment of the invention, it is provided with a server communicable with a mobile device through a network after a prescribed authentication, the server comprising: a main control unit handling an entire control; a display control unit producing screen data as to control a screen display on the mobile device; a time stamp acquisition unit for detecting an event including dispatch, scene arrival, scene departure, onscene observatory finding, observatory finding during transportation, hospital arrival, and diagnosis, treatment, and outcome in hospital from the mobile device and for acquiring a time stamp; an information registration unit for receiving information registration; a list production unit for listing active status of the hospital based on the registered information; and a severity/urgency determination unit for determining emergency degree and severity of illness or injury state based on at least the registered information and a performance standard on transportation and acceptance of a sick or injured person determined by each municipality.

In accordance with a second embodiment of the invention, it is provided with a system for assisting control of rescuing medical services, comprising a mobile device, an association server communicable with the mobile device through a network, and a statistical server, wherein the association server includes: a main control unit handling an entire control; a display control unit producing screen data as to control a screen display on the mobile device; a time stamp acquisition unit for detecting an event including dispatch, scene arrival, scene departure, onscene observatory finding, observatory finding during transportation, hospital arrival, and diagnosis, treatment, and outcome in hospital from the mobile device and for acquiring a time stamp; an information registration unit for receiving information registration; a list production unit for listing active status of the hospital based on the registered information; and a severity determination unit for determining emergency degree and severity of illness or injury state based on at least the registered information and a prescribed standard determined by each municipality, wherein the statistical server produces a prescribed report automatically and periodically based on the acquitted time stamp and the registered information, and wherein the display control unit controls to display a list of possible transport destination medical institutions corresponding to a particular illness or injury state where the severity determination unit assumes a doubt on the respective corresponding medical institutions and the particular illness or injury state based on the emergency degree and severity of the illness or injury state and on a list of corresponding transport destination medical institutions determined by each municipality.

In accordance with a third embodiment of the invention, it is provided with a mobile device communicable with a server through a network after a prescribed authentication, comprising: a main control unit handing an entire control; a communication control unit for communications; a display control unit for controlling display based on screen data; an input unit for receiving an input of an event including dispatch, scene arrival, scene departure, onscene observatory finding, observatory finding during transportation, hospital arrival, and diagnosis, treatment, and outcome in hospital; a severity determination unit for determining emergency degree and severity of illness or injury state based on at least the registered information and a performance standard on transportation and acceptance of a sick or injured person determined by each municipality; and a display unit for making display, wherein the display control unit controls the display unit to display a list of possible transport destination medical institutions corresponding to a particular illness or injury state where the severity determination unit assumes a doubt on the respective corresponding medical institutions and the particular illness or injury state based on the emergency degree and severity of the illness or injury state and on a list of corresponding transportation destination medical institutions determined by each municipality.

In addition to the above, the invention can provide a system for commonly owning information with acute care medical facility serving as candidates for transportation destinations about observations and treatment consequences done by the EMTs. This invention also can provide a system for commonly owning information on the occurrence status of patients in the entire areas and the consultation status of the emergency medical institutions. Furthermore, this invention can provide a system for integrating the consultation records of the patient transported in emergency.

### Advantages of the Invention

According to the system for assisting control of rescuing medical services, the server, and the mobile device of this invention, a reasonable decision can be made by decision making of a EMTs and clinicians at medical institutions based on “the same” information, and the optimal decision can be made corresponding to the situation by rendering all emergency relating persons know the emergency medical information of the entire prefecture level, thereby resultantly shortening the transportation time and time “from onset to treatment,” improving patient's outcomes, and periodically evaluating emergency transportation standard rules and the hospital list and improving them.

### BRIEF DESCRIPTION OF THE DRAWINGS

FIG. 1 is a schematic illustration showing a network of a system for assisting control of rescuing medical services according to an embodiment of the invention.

FIG. 2 is an illustration showing terminals used in the system for assisting control of rescuing medical services and showing an access form from the terminals to a server.

FIG. 3 is a table summarizing, in a comparing manner, connection form, terminal form, internet connection, and user.

FIG. 4 is an illustration showing an outline of security measures in a system phase for the system for assisting control of rescuing medical services according to the embodiment of the invention.

FIG. 5 is a block diagram showing a server structure in the system for assisting control of rescuing medical services according to the embodiment of the invention.

FIG. 6 is a flowchart showing detailed processing steps done by the system for assisting control of rescuing medical services according to the embodiment of the invention.

FIG. 7 is a diagram showing a database structure.

FIG. 8 is a diagram showing a structure of a patient list 401.

FIG. 9 is a diagram showing a structure of an anamnesis list 402.

FIG. 10 is a diagram showing a structure of a transportation list 403.

FIG. 11 is a diagram showing a structure of a patient transportation instruction list 404.

FIG. 12 is a diagram showing a structure of a patient condition detail list 405.

FIG. 13 is a diagram showing a structure of a terminal side hospital status list produce request list 406.

FIG. 14 is a diagram showing a structure of a transportation EMT member list 407.

FIG. 15 is a diagram showing a structure of a EMT treatment record list 408.

FIG. 16 is a diagram showing a structure of an acceptance request list 409.

FIG. 17 is a diagram showing a structure of a patient transfer acceptance request list 410.

FIG. 18 is a diagram showing a structure of a terminal side hospital status list 411.

FIG. 19 is a diagram showing a structure of a transportation destination hospital list 412.

FIG. 20 is a diagram showing a structure of an acceptance list 413.

FIG. 21 is a diagram showing a structure of a treatment detail list 414.

FIG. 22 is a diagram showing structures of a hospital status list 415, a hospital schedule management information list 416, a hospital schedule detailed information list 417, and a rotation information list 418.

FIG. 23 is a flowchart describing an example of a judgment algorism of severity degree and urgency degree.

FIG. 24 is a diagram showing a display example of a dispatch to scene arrival screen 501.

FIG. 25 is a diagram showing a display example of an initial branching screen 502.

FIG. 26 is a diagram showing a display example of a consciousness status input panel 503.

FIG. 27 is a diagram showing a display example of a blood pressure input panel 504.

FIG. 28 is a diagram showing a display example of a pulse input panel 505.

FIG. 29 is a diagram showing a display example of a respiratory input panel 506.

FIG. 30 is a diagram showing a display example of a body temperature input panel 507.

FIG. 31 is a diagram showing a display example of a SpO2 input panel 508.

FIG. 32 is a diagram showing a display example of an acceptance allowed/denied status screen 509.

FIG. 33 is a diagram showing a display example of a communication item panel 510.

FIG. 34 is a diagram showing a display example of an acceptance allowed/denied input screen 511.

FIG. 35 is a diagram showing a display example of a background and transportation origin input panel 512.

FIG. 36 is a diagram showing a display example of an unacceptable reason input panel 513.

FIG. 37 is a diagram showing an example of a hospital side input screen 600.

FIG. 38 is a diagram showing a display screen 601 of an emergency patient occurrence map.

FIG. 39 is a diagram showing an example of a produced daily report of respective medical institutions.

FIG. 40 is a diagram showing a detailed structure of a mobile terminal 200.

### EMBODIMENTS FOR USE THE INVENTION

Hereinafter, referring to the drawings, suitable embodiments for a system for assisting control of rescuing medical services of the invention are described. It is to be noted that the system for assisting control of rescuing medical services of the invention is not limited to the description below, and can be modified properly as far as not deviated from the subject matter of the invention.

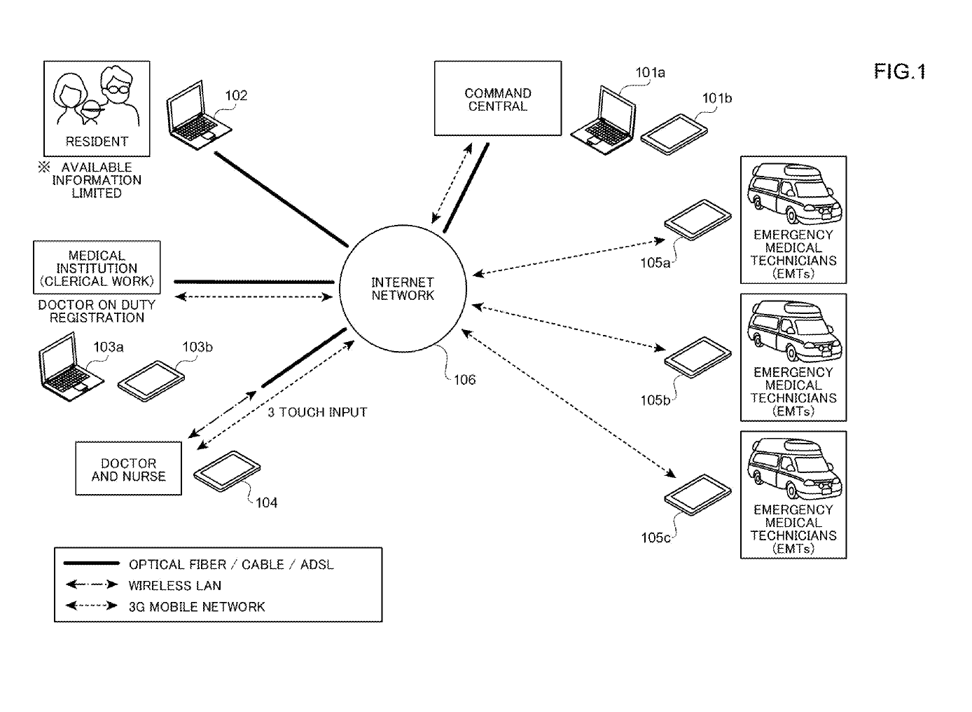

FIG. 1 showing an image illustration of a network of a system for assisting control of rescuing medical services according to the embodiment of the invention, and is described.

As shown in FIG. 1, information terminals 101a such as notebook personal computers or desktop personal computers and tablet type terminals 101b are installed or provided at a command central, and are connected to the Internet network 106 via such as optical fibers, cables, ADSLs, or 3G cellular networks. Residents are connected to the Internet network 106 via such as optical fibers, cables, ADSLs, or 3G cellular networks using information terminals 102 such as notebook personal computers. Medical institutions (office) are connected to the Internet network 106 via such as optical fibers, cables, ADSLs, or 3G cellular networks using information terminals 103a such as notebook personal computers and tablet type terminals 103b. Doctors and nurses are connected to the Internet network 106 via a wireless LAN (inside hospital) and via such as optical fibers, cables, ADSLs, or 3G cellular networks using tablet type terminals 104.

Programs to be installed are two types: first, a thin client program utilized mainly in movable terminals (which is a pure SaaS [software as a service] operated with a browser, but most of algorisms are executed on a server), and second, a rich client program (in which a framework is installed for downloading proper contents, but most of algorisms are executed on the client side). Both allow connections in a regular connection style regardless network use provided by particular venders. The mobile terminals for rich client are suitably having a rigid structure durable for daily use by EMTs, and with such a terminal, connectable WANs (wide area network) serving as 3G mobile telephone networks (e.g., FOMA, WiMAX, E-Mobile, etc.) can be selected.

The thin client is made in supposing accesses from regular notebook and desktop computers, and is designed as to be capable of corresponding to any of wired lines of respective types such as, e.g., ISDN, ADSL, CATV, and optical fiber. When considering the current state that many medical institutions restricts Internet access from intra-hospital terminals, it is required to add the access form to the WAN described above as a choice for accesses from medical institutions, and CATV may be considered for future developments in an area in which CATV is the major network infra.

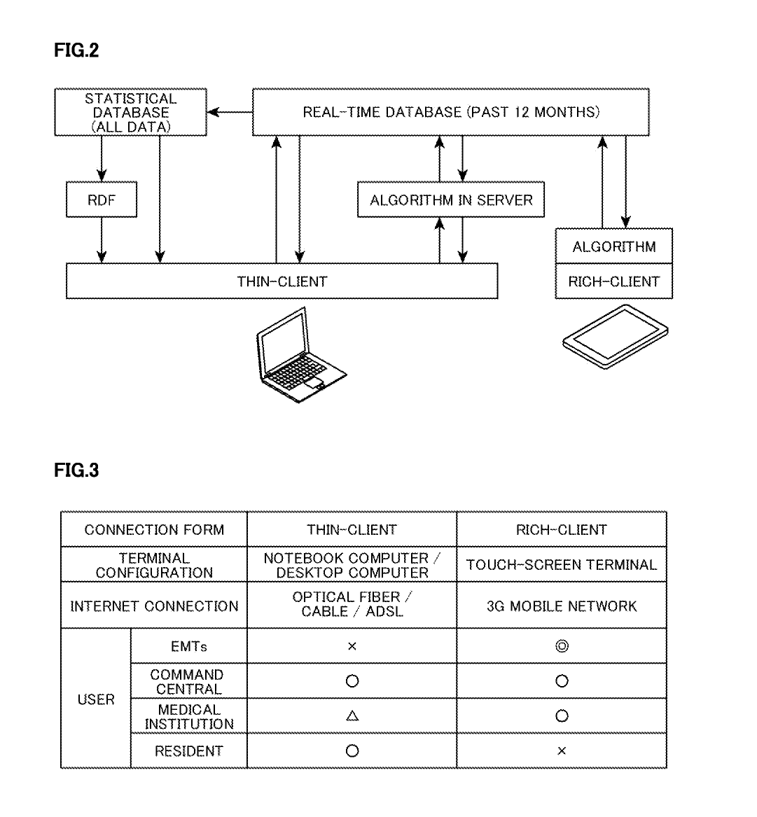

FIG. 2 shows terminals used in the system for assisting control of rescuing medical services and an access form from respective terminals to the association server, and it is described. As described above, it is assumed that the terminals having a rigid structure connectable to the 3G mobile telephone network are used at the EMTs and medical institutions and that personal computer terminals such as notebook type and desktop type are used in other places. In future, this system may be planned to be accessed from general residents for a part of information, and at that time, the access from mobile phone terminals and PDAs may be considered.

FIG. 3 summarizes in a comparing manner the connection form, the terminal form, the internet connection, and user. That is, for the thin client program, notebook and desktop personal computers are adapted as forms of the terminals, and the Internet is connected through the optical fiber cable and ADSL. As users, it is suitable for the command central and the residents. On the other hand, for the rich client program, tablet type terminals are adapted as forms of the terminals, and the Internet is connected through the 3G mobile network. As users, it is especially suitable for the EMTs, but it is reluctantly used by the residents although used at the FDs and the medical institutions.

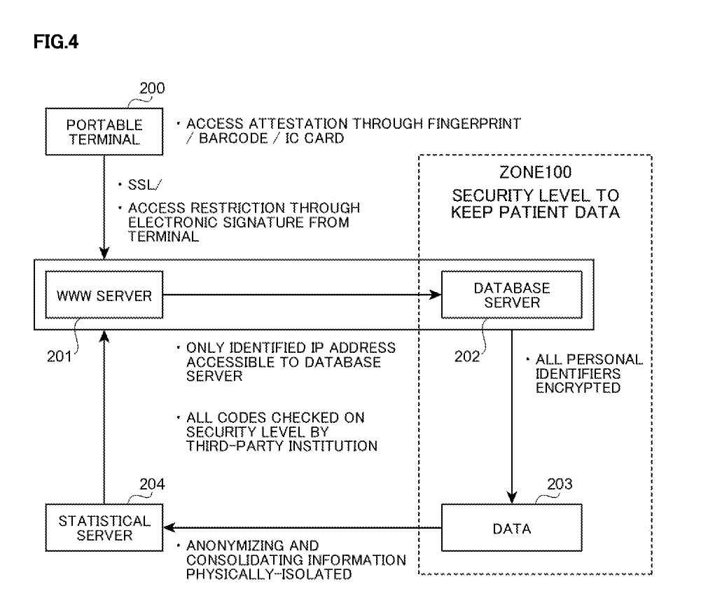

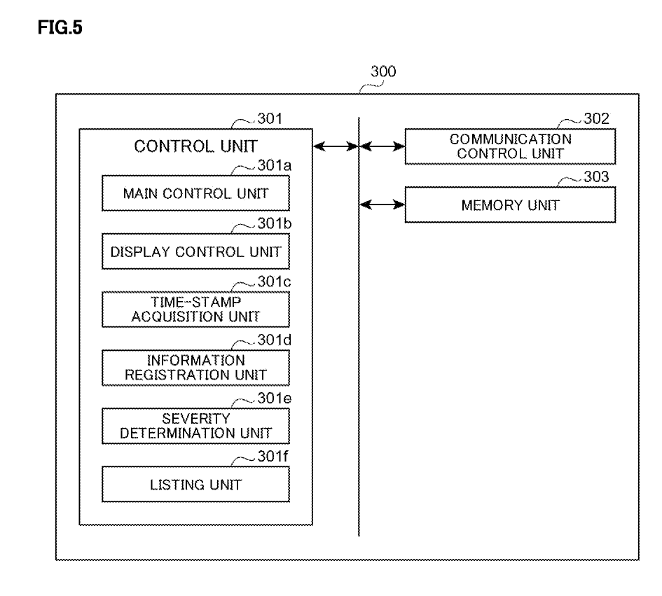

FIG. 4 shows an outline of security measures in a system phase for the system for assisting control of rescuing medical services according to the embodiment of the invention. As shown in FIG. 4, the security of the system for assisting control of rescuing medical service are ensured by the following five levels.

Access to a Terminal 200

An access for the terminal 200 is allowed only for individuals having the permission. For example, verification systems such as ID and password, bar code, IC card, or fingerprint may be utilized.

Access to a www Server 201

As a general rule, an access restriction is made by ID and password. Authorization by digital ID is made for the mobile terminal 200 and the server. Data transmissions are encrypted entirely with SSL.

Access to a Database Server 202

The database server 202 ensures a physical, electrical security level storing patient data of the medical institutions. An access with the IP address given to the www server 201 is exclusively allowed for the database server 202.

Management of Data 203

Entire data possibly identifying any individual (e.g., equivalent to Protected Health Information in U.S., HIPAA) are encrypted and stored.

Data Management of a Statistical Server 204

In the statistical server 204, the entire data are made anonymous. A linking table connectable with the original data is stored in a USB having functions of encryption and access restriction, and is stored in a physically locked storage.

This rescue medical service system has general-purpose property and model property as follows.

Scalability from Use of Cloud

This rescue medical service system takes an SaaS form of a type in which accesses are made to a data center having a security of a level keeping the patient data. The maintenance costs inflicted at respective institutions are reduced for maintenance of the mobile terminal 200 and for updates of software and contents from a centralized management.

Standardization of Information to be Shared Based on a Medical Consensus

Information collected at various rescue systems in the past was not based on a logic base, and the systems were operated frequently in a diversified manner according to the areas. Because of not based on a logic, collected data were not utilized in some cases. With this rescue medical service system, lists of transportation destinations based on hospital achievements and transportation rules based on the medical consensus are installed. Those productions of the list and the rules are on the basis of quality management of medical services.

Open Design not Depending on Vender, OS, and Hardware

From standardization not of the data level but of the information level, free design from venders of medical information systems is possible by obtaining “necessary data for extracting the information” regardless any type of medical information system introduced in respective medical institutions. For the mobile terminal 200 to be used, thin client and rich client programs are developed. The thin client program is planned to be operated with general browsers, and the rich client program is also designed to be operated with general OSs (e.g., MacOS 0.5 or up, Windows (registered trademark) XP or 7).

Next, FIG. 5 shows a structure of an association server in the system for assisting control of rescuing medical services according to the embodiment of the invention. The association server conceptionally includes the www server 200 and the database server 202 in FIG. 4. As shown in FIG. 4, the association server 300 includes a control unit 301, a communication control unit 302, and a memory unit 303. The control unit 301 functions, by executing a control program, a main control unit 301a, a display control unit 301b, a time stamp acquisition unit 301c, an information registration unit 301d, a severity determination unit 301e, and a listing unit 301f. The main control unit 301a handles the control of the entire body. The display control unit 301b produces screen data as to control screen displays at terminals. The time stamp acquisition unit 301c obtains a time stamp upon detection of events such as dispatch, scene arrival, etc. from the terminals. The information registration unit 301d receives information registration from the EMTs and the medical institutions. The severity determination unit 301e calculates patient's severity based on the registered information and the index described below. The listing unit 301f produces a list or the like indicating active status of today's hospitals based on the registered information and the like. The statistical server 204 shown in FIG. 4 previously stores all of the time stamps and the data as a depository, and can make a feedback to the fire department institutions and the medical institutions and can provide information to administrations and residents upon calculation of prescribed indexes (structure, process, outcome, cooperation) based on the acquired time stamps and the registered information.

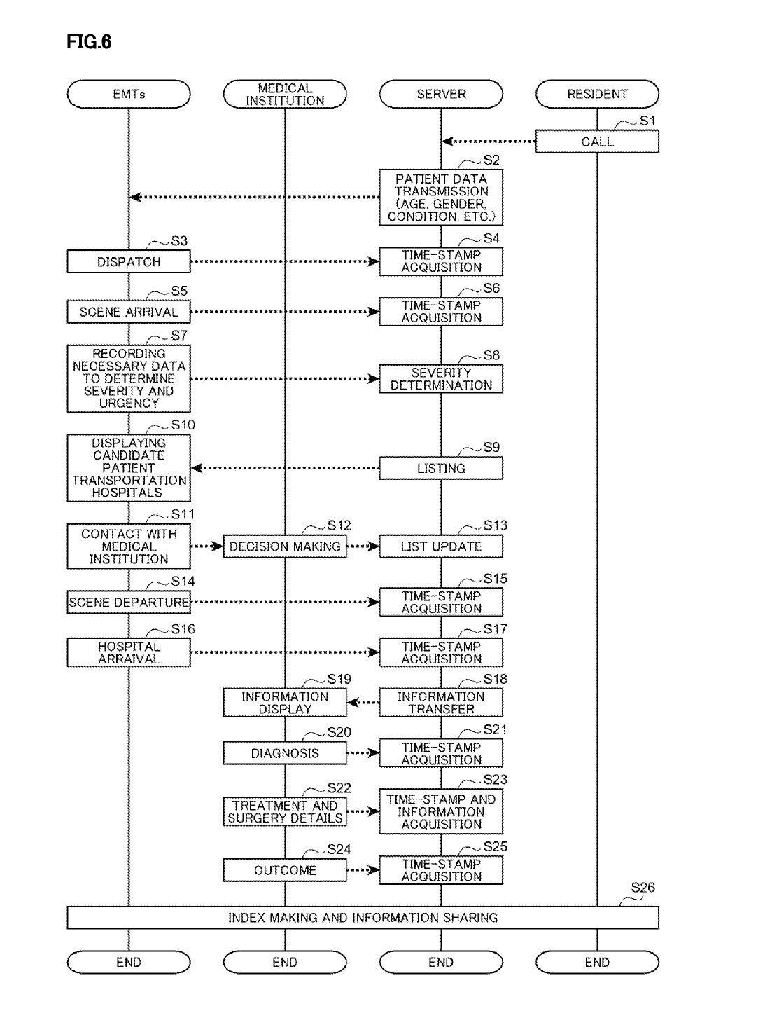

Hereinafter, referring to a flowchart of FIG. 6, processing steps done by the system for assisting control of rescuing medical services according to the embodiment of the invention is described in detail. The recording of the EMT is recorded as a time stamp at a time when a button on the touch panel is tapped. All of the recordings are viewable at a real time through terminals of “transportation destination medical institution.”

When a resident make a call (S1), the server transfers patient's data of age, gender, condition, etc. (S2). After this transfer of the data, the EMT dispatches. At that time a dispatch button of the terminal is tapped (S3), and the server records a time stamp regarding the dispatch (S4).

Then, when the EMT arrives at the scene, a scene arrival button of the terminal is tapped (S5), and the server records a time stamp regarding the scene arrival (S6). The EMT records necessary data for determination of “severity and urgency” on the scene during checks of anamnesis and current medical history and observation of the body (S7). According to these recorded data, the severity is determined from the algorism of severity and urgency determination installed inside the server based on “practice reference of injured or sick person's transportation and acceptance” decided by respective municipalities (S8).

The server displays a list of transportation corresponding medical institutions based on the feature and list of the medical institutions previously registered in a way sorting the list with distance from the scene and busy degree of the respective medical institutions (S9). The terminal of the EMT displays the list of the transportation destination candidates (S 10). This list reflects the status of the respective medical institutions at that day at the real time, and allows the team member to contact a medical institution in avoiding busy medical institutions. The EMT makes a contact to a medical institution upon looking at the list of the transportation destination candidates (S11). The medical institution decides as to whether to accept the patient, and the result is notified to the server (S 12). The server updates the list based on this notification (S13). Thus, the medical institutions and the EMT make most appropriate decisions where sharing the same information such as, e.g., occurrence status of patients within the prefecture, busy degree of the respective medical institutions, and conditions of the patients). It is to be noted that where the patient is not acceptable due to the status of the medical institutions at the time of the EMT's inquiry, the information can be shared by touching of the EMT.

The EMT departs from the scene in this way. At that time, where the departing button is tapped at the terminal (S 14), and the server records the time stamp regarding the scene departure (S15). The EMT arrives at the hospital (hospital arrival). If a hospital arrival button is tapped at that time (S 16), the server records the time stamp regarding the hospital arrival (S17).

After the arrival at the medical institution, the information obtained by the EMT is automatically transferred to the terminal of the medical institution (S18). This information is displayed on the terminal of the medical institution (S 19). When an outpatient diagnosis is set at the medical institution, a diagnosis button is tapped (S20), and the server records the diagnosis contents and the diagnosis time with the time stamp (S21). In a case where any treatment or surgery is made, a treatment and surgery button is tapped (S22), and the server records the time stamp regarding the treatment and surgery (S23). In a case where a final outcome is decided, an outcome button is tapped (S24), and the server records the time stamp regarding the outcome (S25). At that time, three items of “diagnosis,” “procedures and surgery,” and “outcome” of the transported patient are inputted at the medical institution, thereby enabling data integration and information sharing. The server records that the medical institution is busy for a preset certain period of time (e.g., general hospitalization response is one hour, operation for abdomen is three hours, etc.) based on those responses of the medical institutions to the transported patients, and the information is shared among the related persons and is displayed on the medical institution list for selection.

Various indexes are thus produced based on the accumulated information, and then, the information is shared (S26). Thus, a series of processing is completed. The various indexes are relating to verification of the transportation rules and as whether the medical institution properly accepts patients, and basic ones may be installed as the contents, but can be added or updated.

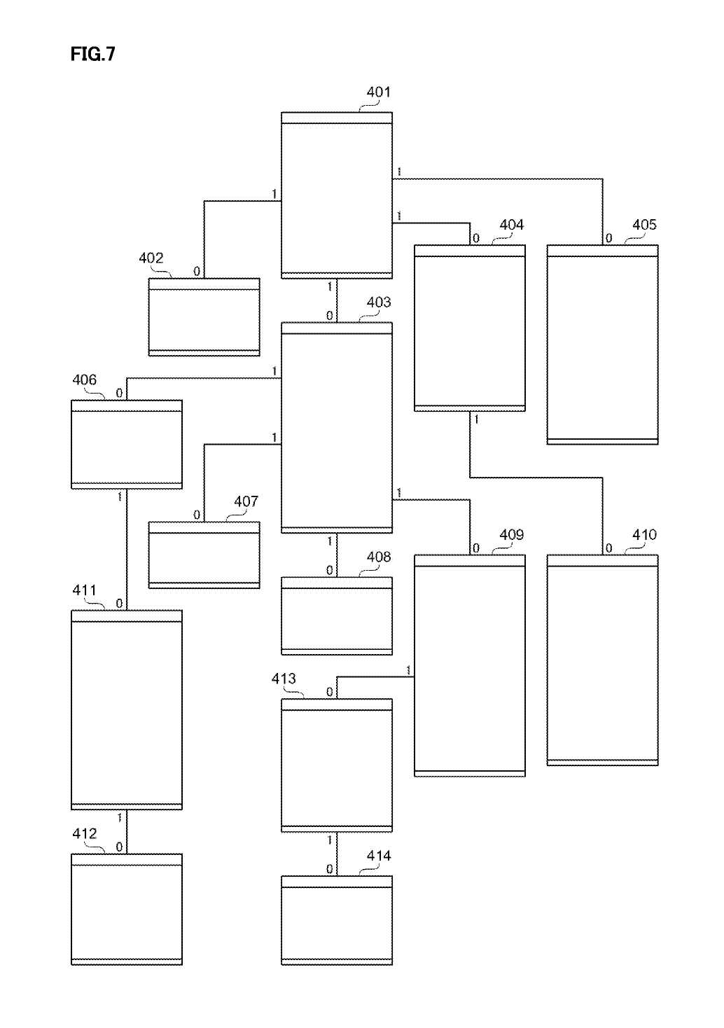

The structure of the database is shown from FIG. 7 to FIG. 22, and is described.

As shown in those drawings, as the databases, what are accumulated in a table method are: a patient list 401, an anamnesis list 402, a transportation list 403, a patient transportation instruction list 404, a patient condition detail list 405, a terminal side hospital status list produce request list 406, a transportation EMT member list 407, a EMT treatment record list 408, an acceptance request list 409, a patient transfer acceptance request list 410, a terminal side hospital status list 411, a transportation destination hospital list 412, a structure of an acceptance list 413, a treatment detail list 414, a hospital status list 415, a hospital schedule management information list 416, a hospital schedule detailed information list 417, and a rotation information list 418.

It is to be noted that what is shown as “1” and “0” in FIG. 7 is an entity relation that “1” is a necessary list with respect to “0” whereas “0” is not necessary with respect to “1.”

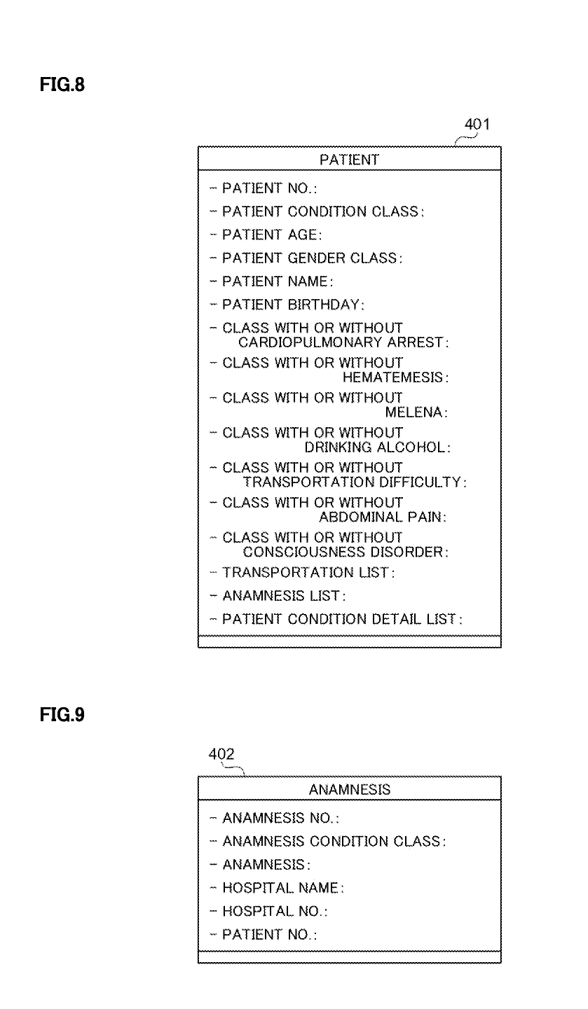

More specifically, the patient list 401 (see FIG. 8) contains: patient no., patient condition class, patient age, patient gender class, patient name, patient birthday, class with or without cardiopulmonary arrest, class with or without hematemesis, class with or without melena, class with or without drinking alcohol, class with or without transportation difficulty, class with or without abdominal pain, class with or without consciousness disorder. The list is also linked to the anamnesis list 402, the transportation list 403, the patient transportation instruction list 404, and the patient condition detail list 405. The items in the patient list 401 can be properly added, deleted, or integrated. This is the same as in other lists described below. The anamnesis list 402 (see FIG. 9) contains: anamnesis no., anamnesis condition class, anamnesis, hospital name, hospital no., and patient no.

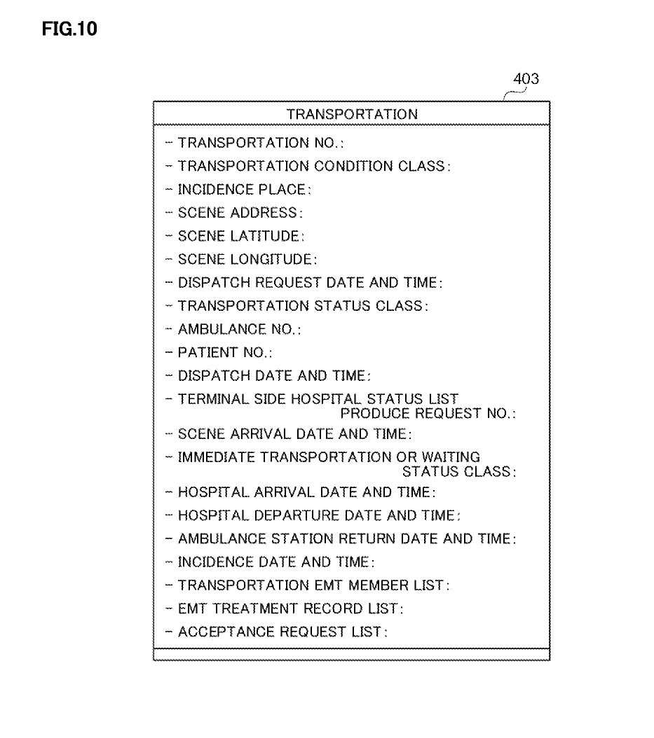

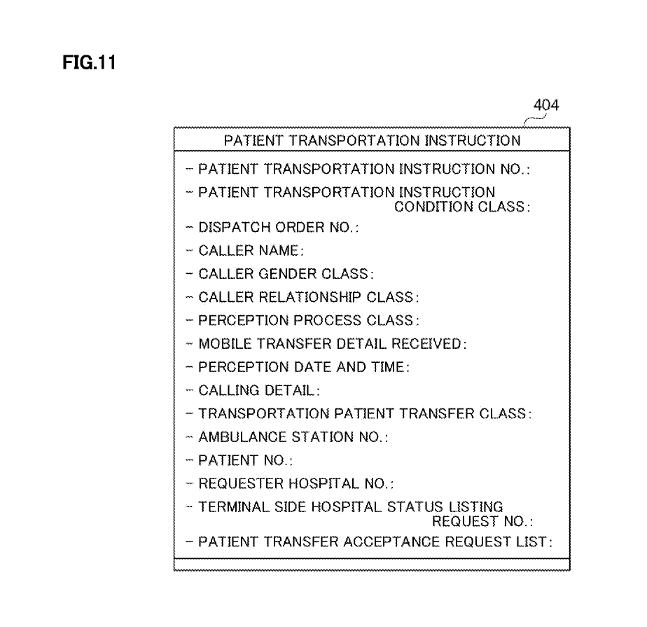

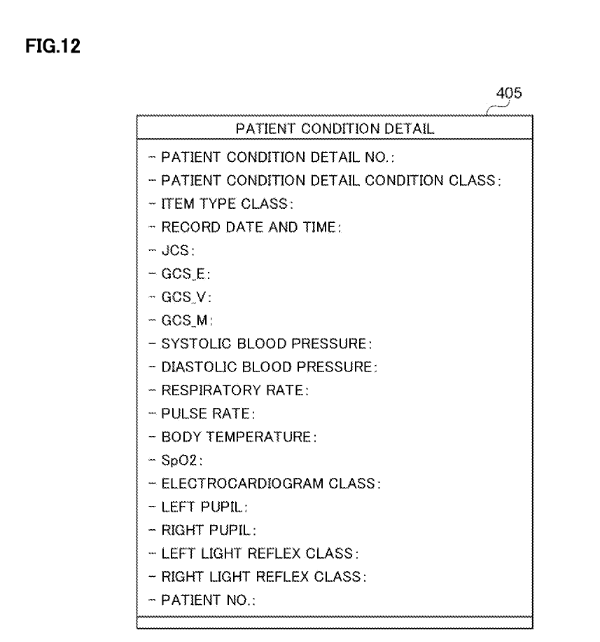

The transportation list 403 (see FIG. 10) contains: transportation no., transportation condition class, incidence place, scene address, scene latitude, scene longitude, dispatch request date and time, transportation status class, ambulance no., patient no., dispatch date and time, terminal side hospital status list produce request no., scene arrival date and time, immediate transportation or waiting status class, hospital arrival date and time, hospital departure date and time, ambulance station return date and time, and incidence date and time, and the list is also linked to a transportation EMT member list 407, a EMT treatment record list 408, and an acceptance request list 409. The patient transportation instruction list 404 (see FIG. 11) contains: patient transportation instruction no., patient transportation instruction condition class, dispatch order no., caller name, caller gender class, caller relationship class, perception process class, mobile transfer detail received, perception date and time, calling detail, transportation patient transfer class, ambulance station no., patient no., requester hospital no., and terminal side hospital status listing request no. The list is also linked to a patient transfer acceptance request list 410.

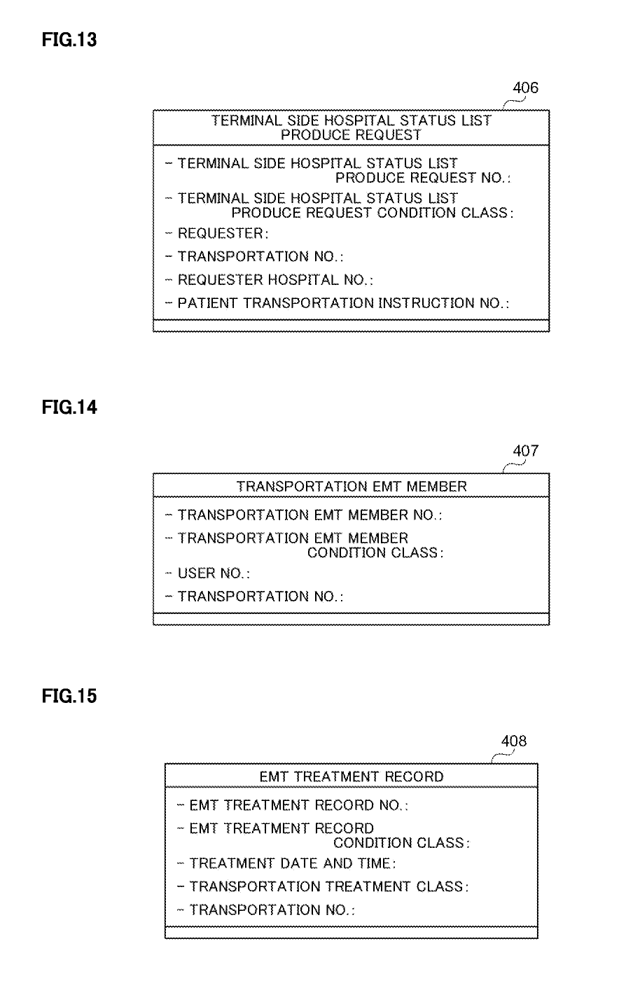

The patient condition detail list 405 (see FIG. 12) contains: patient condition detail no., patient condition detail condition class, item type class, JCS, GCS_E, GCS_V, GCS_M, systolic blood pressure, diastolic blood pressure, respiratory rate, pulse rate, body temperature, SpO2, electrocardiogram class, left pupil, right pupil, left light reflex class, right light reflex class, and patient no. The terminal side hospital status list produce request list 406 (see FIG. 13) contains: terminal side hospital status list produce request no., terminal side hospital status list produce request condition class, requester, transportation no., requester hospital no., and patient transportation instruction no. The transportation EMT member list 407 (see FIG. 14) contains: transportation EMT member no., transportation EMT member condition class, user no., and transportation no. The EMT treatment record list 408 (see FIG. 15) contains: EMT treatment record no., EMT treatment record condition class, treatment date and time, transportation treatment class, and transportation no.

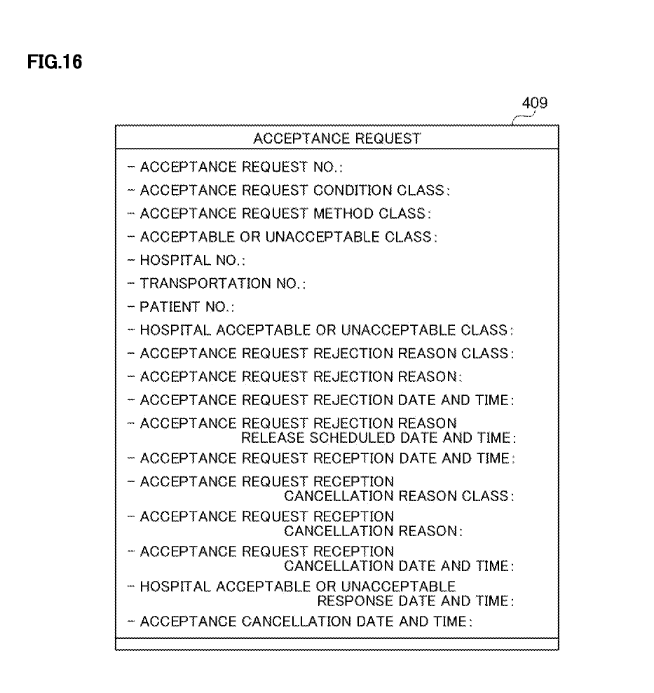

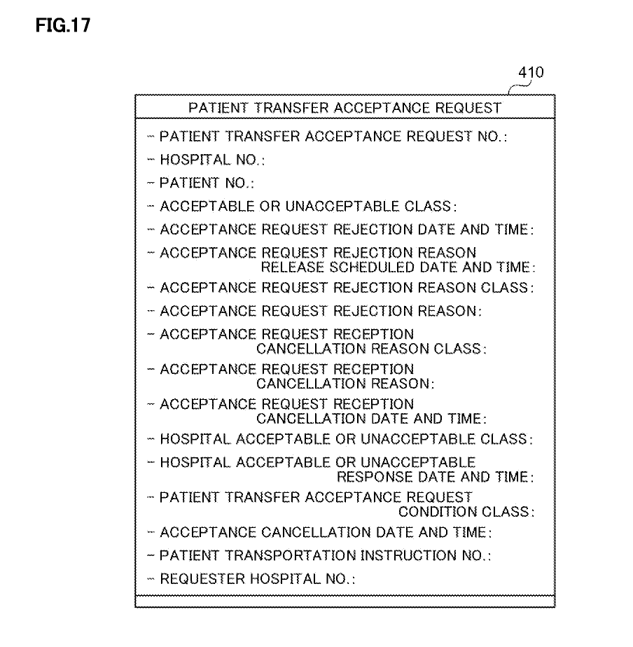

The acceptance request list 409 (see FIG. 16) contains: acceptance request no., acceptance request condition class, acceptance request method class, acceptable or unacceptable class, hospital no., transportation no., patient no., hospital acceptable or unacceptable class, acceptance request rejection reason class, acceptance request rejection reason, acceptance request rejection date and time, acceptance request rejection reason release scheduled date and time, acceptance request reception date and time, acceptance request reception cancellation reason class, acceptance request reception cancellation reason, acceptance request reception cancellation date and time, hospital acceptable or unacceptable response date and time, and acceptance cancellation date and time. The patient transfer acceptance request list 410 (see FIG. 17) contains: patient transfer acceptance request no., hospital no., patient no., acceptable or unacceptable class, acceptance request rejection date and time, acceptance request rejection reason release scheduled date and time, acceptance request rejection reason class, acceptance request rejection reason, acceptance request reception cancellation reason class, acceptance request reception cancellation reason, acceptance request reception cancellation date and time, hospital acceptable or unacceptable class, hospital acceptable or unacceptable response date and time, patient transfer acceptance request condition class, acceptance cancellation date and time, patient transportation instruction no., requester hospital no.

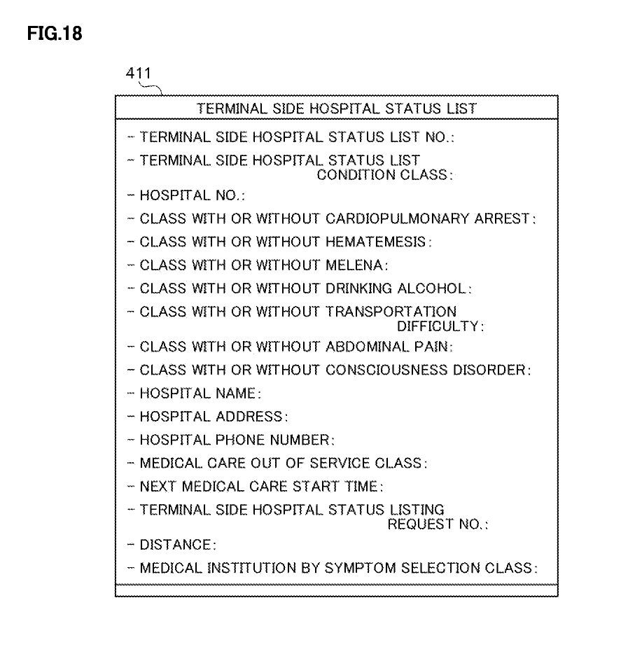

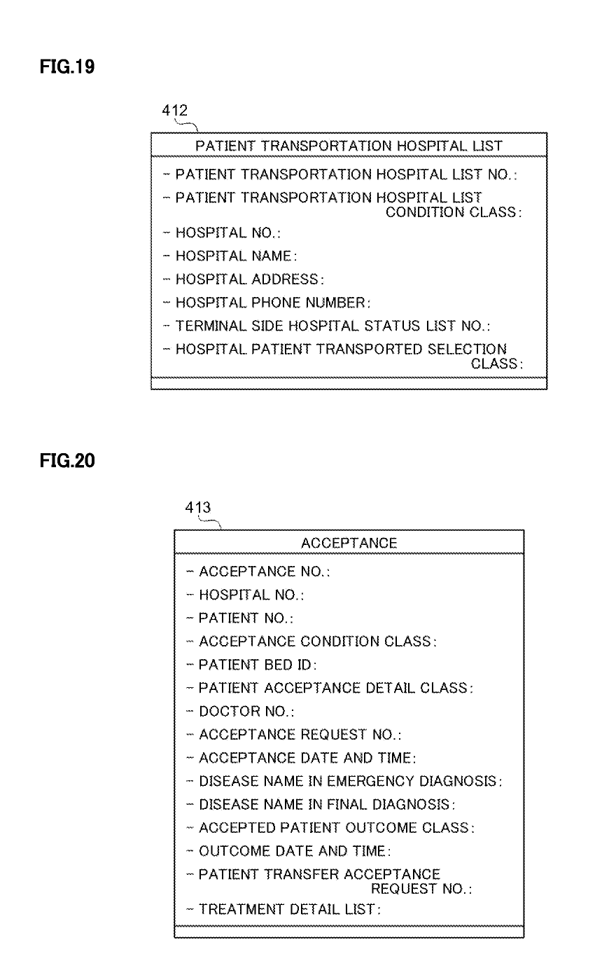

The terminal side hospital status list 411 (see FIG. 18) contains: terminal side hospital status list no., terminal side hospital status list condition class, hospital no., class with or without cardiopulmonary arrest, class with or without hematemesis, class with or without melena, class with or without drinking, class with or without transportation difficulty, class with or without abdominal pain, class with or without consciousness disorder, hospital name, hospital address, hospital phone number, medical care out of service class, next medical care start time, terminal side hospital status listing request no., distance, and medical institution by symptom selection class. The patient transportation hospital list 412 (see FIG. 19) contains: patient transportation hospital list no., patient transportation hospital list condition class, hospital no., hospital name, hospital address, hospital phone number, terminal side hospital status list no., and hospital patient transported selection class.

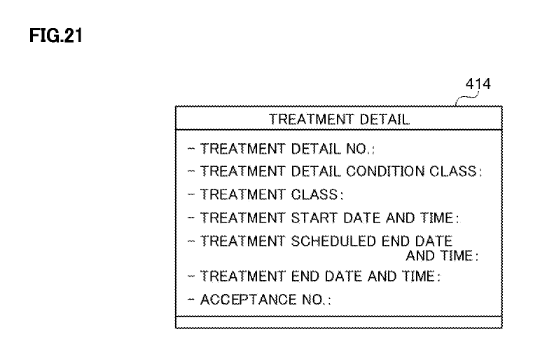

The acceptance list 413 (see FIG. 20) contains: acceptance no., hospital no., patient no., acceptance condition class, patient bed id, patient acceptance detail class, doctor no., acceptance request no., acceptance date and time, disease name in emergency diagnosis, disease name in final diagnosis, accepted patient outcome class, outcome date and time, and patient transfer acceptance request no., and the list is also linked to the treatment detail list 414. The treatment detail list 414 (see FIG. 21) contains: treatment detail no., treatment detail condition class, treatment class, treatment start date and time, treatment scheduled end date and time, treatment end date and time, and acceptance no.

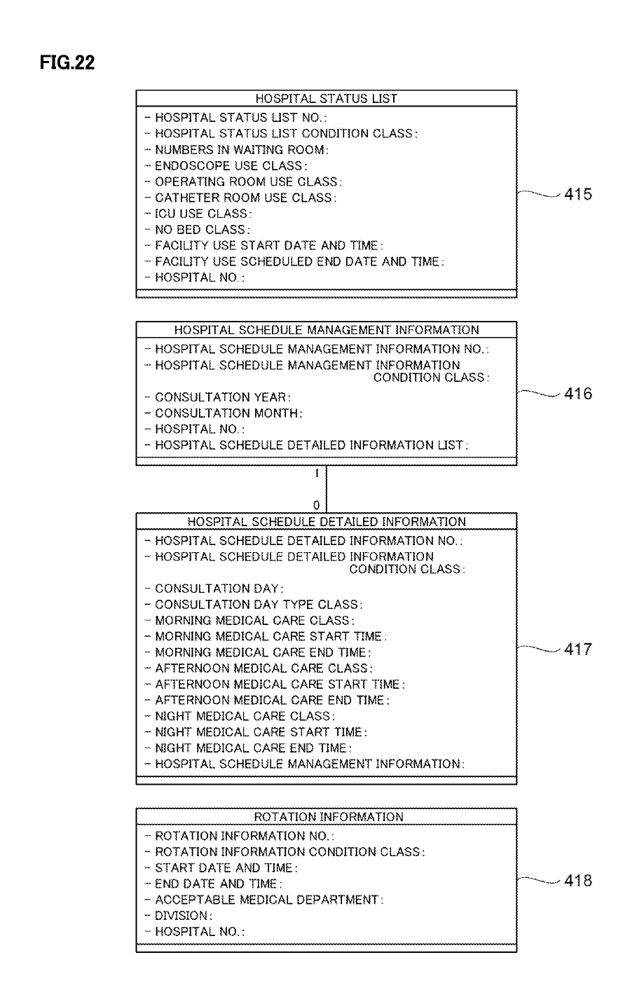

The hospital status list 415 (see FIG. 22) contains: hospital status list no., hospital status list condition class, numbers in waiting room, endoscope use class, operating room use class, catheter room use class, ICU use class, fully occupied bed class, facility use start date and time, facility use scheduled end date and time, and hospital no. The hospital schedule management information list 416 (see FIG. 22) contains: hospital schedule management information no., hospital schedule management information condition class, consultation year, consultation month, and hospital no. The hospital schedule detailed information list 417 (see FIG. 22) contains: hospital schedule detailed information no., hospital schedule detailed information condition class, consultation day, consultation day type class, morning medical care class, morning medical care start time, morning medical care end time, afternoon medical care class, afternoon medical care start time, afternoon medical care end time, night medical care class, night medical care start time, night medical care end time, and hospital schedule management information no. The rotation information list 418 (see FIG. 22) contains: rotation information no., rotation information condition class, start date and time, end date and time, acceptable medical department, division, and hospital no.

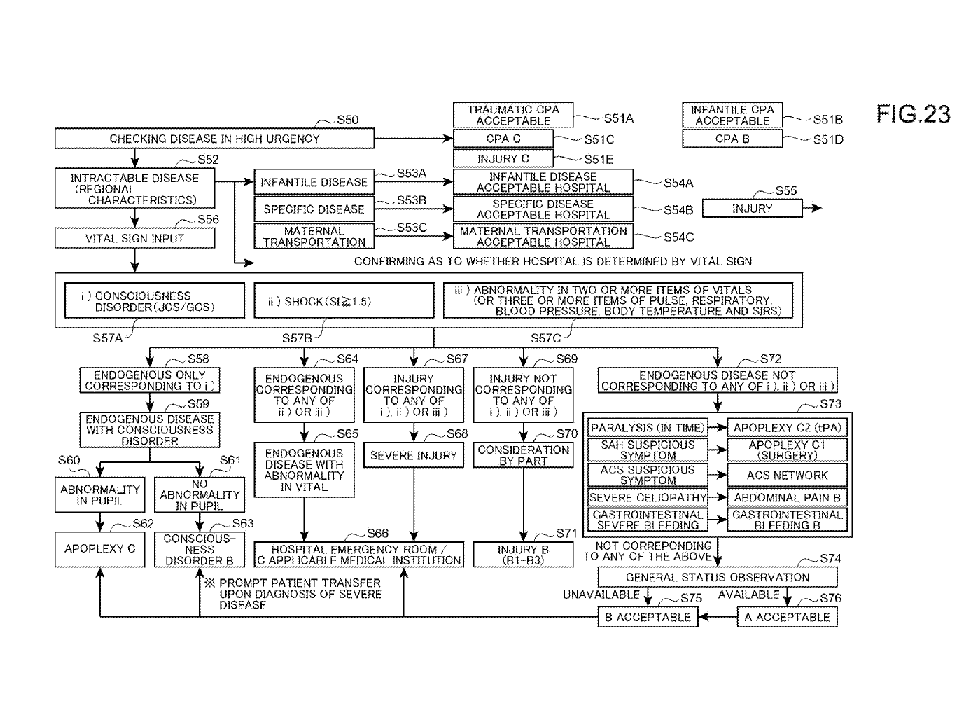

Hereinafter, referring to the flowchart of FIG. 23, an example of a judgment algorism of severity and urgency degree is described in detail. The judgment algorism of severity and urgency degree may be different according to progresses of medical services, various research results, and localizations, and the judgment references can be added, modified, and deleted properly. The judgment of severity degree and urgency degree is executed by the severity determination unit 301e. In the subsequent paragraph, the judgment process is described based on the algorism of the present time.

When the processing starts, a screen for asking whether the patient is in a deadly disease, e.g., CPA[cardiopulmonary arrest] or heavy injured, comes out (S50). In a case where a deadly disease is chosen, the respective corresponding hospitals are set as the transportation destinations (S51A to S51E). That is, in accordance with a screen selection on the terminal, traumatic CPA acceptable (S51A), infant CPA acceptable (S51B), CPA C (S51C), CPA B (S51D), and injury C (S51E) are determined as transportation destinations. Herein, “C” means heavy disease; “B” means middle level; and “A” means light disease. It is to be noted that those classifications are different according to progresses of medical services, various research results, and localizations.

In a case where a transportation destination for particular disease or sickness in consideration of localized characteristics, the respective acceptable hospital can be selected. In this example, in a case of an infantile disease (S53A), an infantile disease acceptable hospital is determined as the transportation destination (S54A); in a case of a specific disease (S53B), a specific disease acceptable hospital is determined as the transportation destination (S54B); in a case of a maternal transportation (S53C), a maternal transportation acceptable hospital is determined as the transportation destination (S54C); and in a case of an injury, other hospitals are selected as the transportation destinations.

When vital sign, consciousness level, anticipated disease name and the patient's status are inputted (S56), the transportation destination is determined based on the information. In a case of a high urgency, or namely in a case of i) consciousness disorder (JCS/GCS) existence (S57A), ii) shock (SI not less than 1.5) existence (S57B), and iii) abnormality in two or more vital items (or three or more items of pulse, respiration, blood pressure, body temperature, and SIRS) existence (S57C), the transportation destination candidates are indicated based on “transportation responding medical institution list” capable of responding to heavy disease or injury decided by respective municipalities.

Herein, in a case of endogenous cases satisfying only i) (S58), the transportation destination candidates are indicated based on “transportation responding medical institution list” decided by respective municipalities based on that status. For example, with the algorism at this time, in a case of endogenous disease with consciousness disorder (S59), and in a case of abnormality in pupil (S60), apoplexy C acceptable hospitals are determined as the transportation destination (S62); in a case of no abnormality in pupil (S61), consciousness disorder B acceptable medical institutions are displayed as the candidates (S63). In a case where it is endogenous in which any of ii) and iii) is satisfied (S64), it is an endogenous disease with abnormality in vital (S65), and hospitals with emergency rooms and C acceptable medical institutions are indicated as the candidates (S66). In a case where it is an injury satisfying any of i) through iii) (S67), it is server injury (S68), and hospitals with emergency rooms and C acceptable medical institutions are indicated as the candidates (S66) in substantially the same way as above. In a case where it is an injury not satisfying all of i) through iii) (S69), consideration by part is conducted (S70), injury B (B1 to B3) acceptable medical institutions are indicated as the candidates (S71).

In a case where it is endogenous disease not satisfying any of i) through iii) (S72), apoplexy C2 (tPA) acceptable hospitals are indicated because it becomes a correspondence for the tPA (tissue plasminogen activator) method where paralysis occurs during a certain period of time or less (the current guideline shows it is within three hours but may be modified since adapting more symptoms). In a case where “a strong head ache not experienced in the past” or the like providing a doubt of the SAH (subarachnoid hemorrhage) is observed, apoplexy C1 (brain emergency surgery) acceptable medical institutions are indicated as the candidates. In a case that it is doubtful as ACS (acute coronary syndrome), ACS network corresponding medical institutions are indicated as the candidates; in a case of severe abdominal pain, abdominal pain B acceptable medical institutions are indicated as the candidates; in a case of severe gastrointestinal bleeding, gastrointestinal bleeding B acceptable medical institutions are indicated as the candidates. In a case that it is not any of the above cases, an observation of the whole body status is made (S74); if it is unavailable, B acceptable hospitals are indicated as the candidates (S75); if is available, A acceptable hospitals are indicated as the candidates (S76); in a case where the physical status is suddenly changed after the transportation to become severe disease, the transportation destination candidates of S62 through S66 are indicated rapidly.

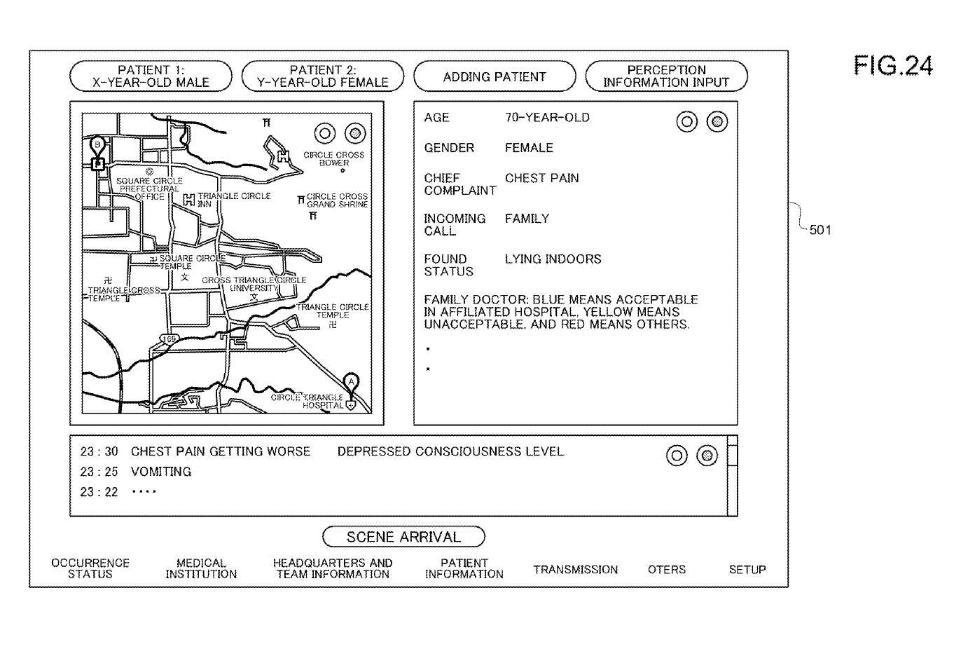

Hereinafter, referring to FIG. 24 through FIG. 36, an example of a screen transition on the terminal is described. Screen data for the terminals produced under control of the display control unit 301b of the server. The information inputted from the terminals is registered through the information registration unit 301d of the server. The list displayed on the terminals is produced by the listing unit 301f of the server.

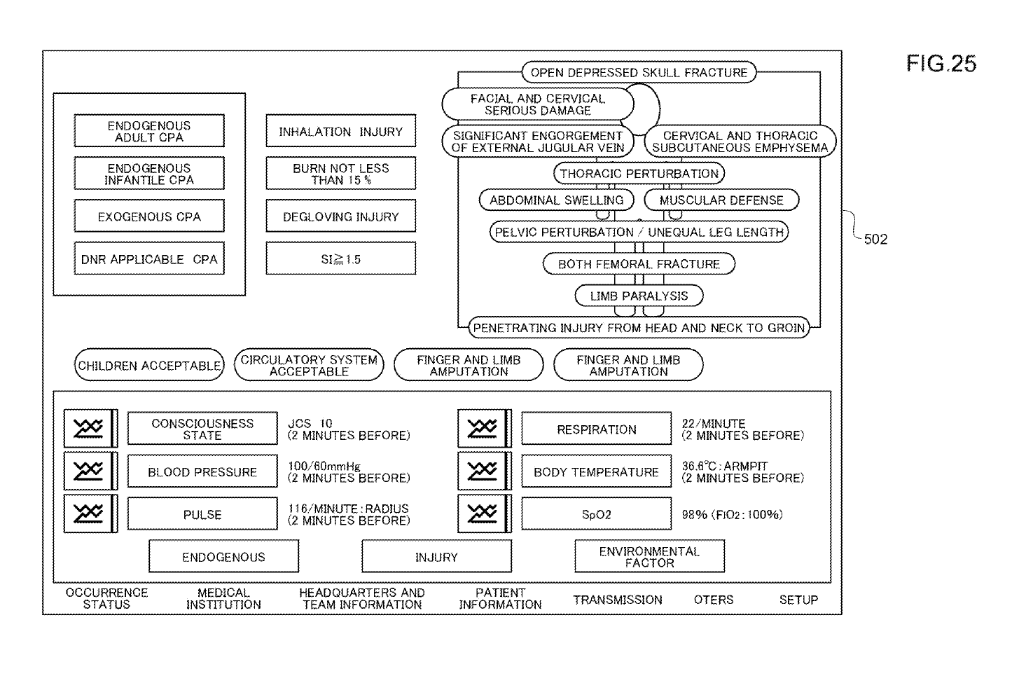

FIG. 24 shows a dispatch to scene arrival screen 501. This screen 501 displays a display area (map) of the route from the scene to the hospitals, a display area of perception information such as patient's age, gender, chief complaint, incoming call, and found status, and a display area of ongoing information regarding the symptom, and is formed with a scene arrival button. If the scene arrival button is tapped, the screen is transited to an initial branching screen 502 shown in FIG. 25. In this screen 502, an input designation area for highly emergency diseases located on a left upper side, an input designation area for specified diseases at a center, an input area for part basis diseases located on a right upper side, and a vital sign input area located on a lower side are formed. Consciousness state, blood pressure, pulse, respiration, body temperature, and SpO2 can be inputted as vital signs. It is, however, not limited to those, as a matter of course.

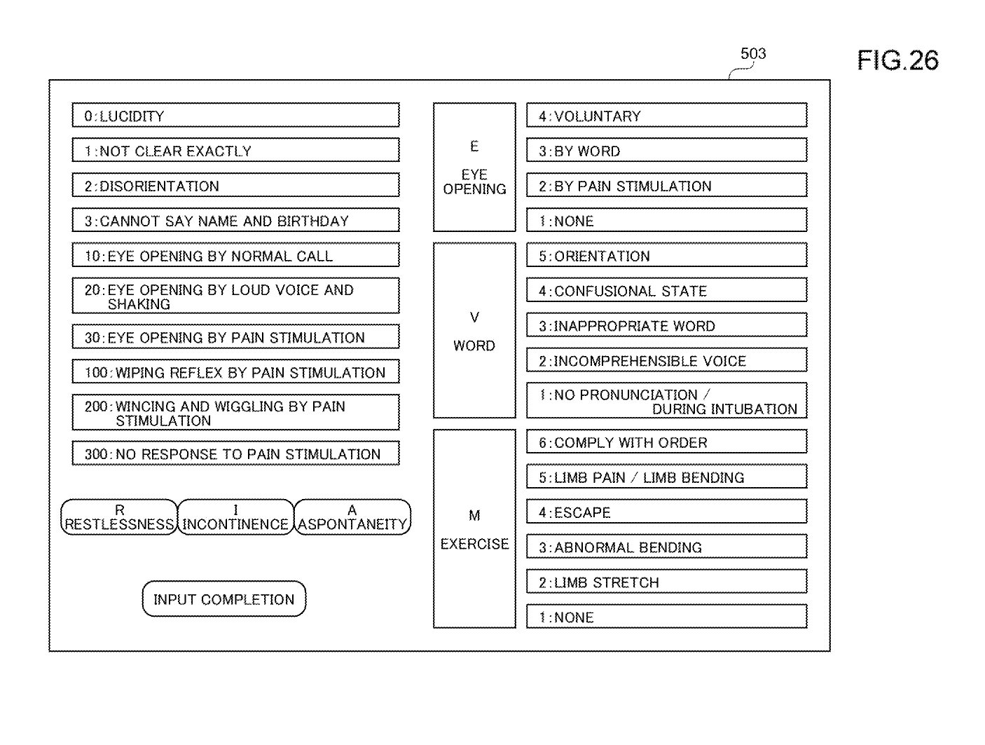

If the “consciousness state” button of the vital sign input area is tapped, a consciousness state input panel 503 as shown in FIG. 26 is displayed. With this panel 503, one is selected among ten items regarding JCS; items fitting are selected among restlessness, incontinence, aspontaneity (selectable plural items); one item is selected from E eye opening, V word, and M exercise; and then, an input completion button may be tapped.

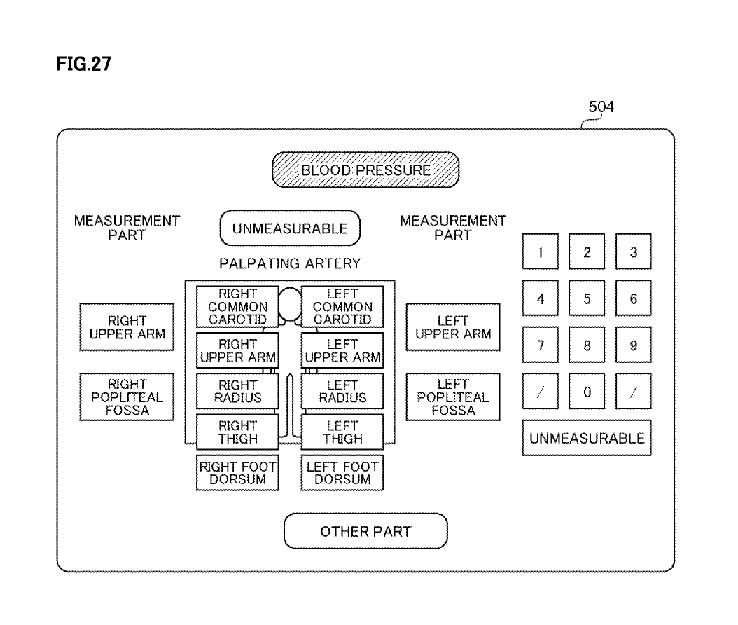

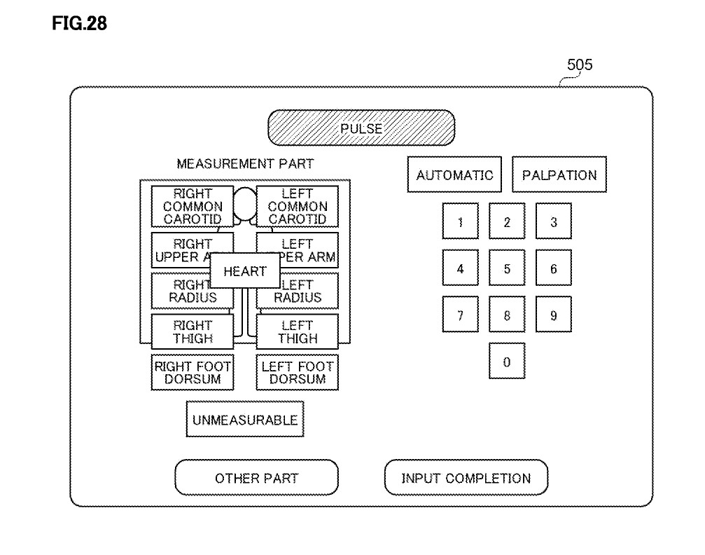

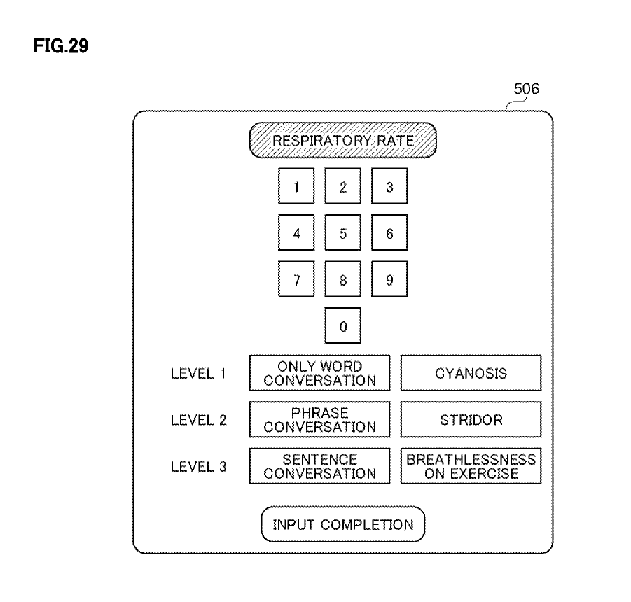

When a “blood pressure” button in the vital sign input area is tapped, a blood pressure input panel 504 as shown in FIG. 27 is displayed. With this panel 504, a measurement part is selected, and a number of the blood pressure is inputted. Palpating is displayed in a gray color until tapping of an unmeasurable button. When a “pulse” button in the vital sign input area is tapped, a pulse input panel 505 as shown in FIG. 28 is displayed. With this panel 505, a measurement part is selected, and the number of the pulse is entered. When a “respiratory rate” button in the vital sign input area is tapped, a respiratory input panel 506 as shown in FIG. 29 is displayed. With this panel 506, a symptom fitting to the patient is selected from levels of one through three. In this example, “only word conversation” and “cyanosis” can be selected at the level one; “phrase conversation” and “stridor” can be selected at the level two; and “sentence conversation” and “breathlessness on exercise” can be selected at the level three.

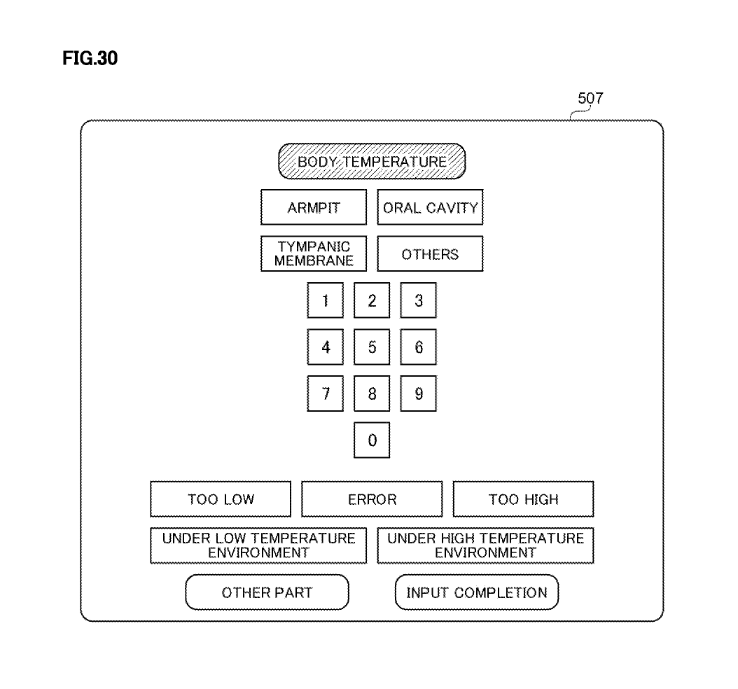

When a “body temperature” button in the vital sign input area is tapped, a body temperature input panel 507 as shown in FIG. 30 is displayed. With this panel 507, a measurement part of the body temperature is selected, and a number is inputted. When three numbers are entered, the first digit of the decimal is indicated. In addition, under low temperature environment and under high temperature environment can be entered for the measuring environment.

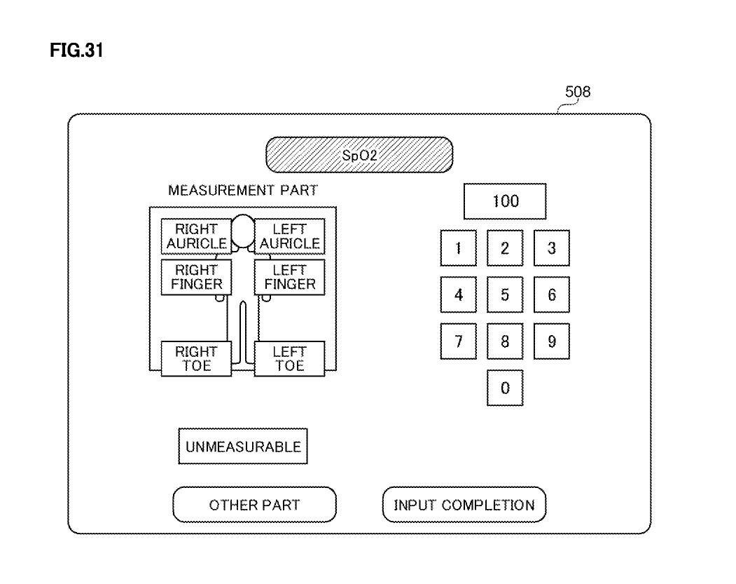

When an “SpO2” button in the vital sign input area is tapped, an SpO2 input panel 508 as shown in FIG. 31 is displayed. With this panel 508, a measurement part and number (percent) of the SpO2 (arterial oxygen saturation) of the patient are entered.

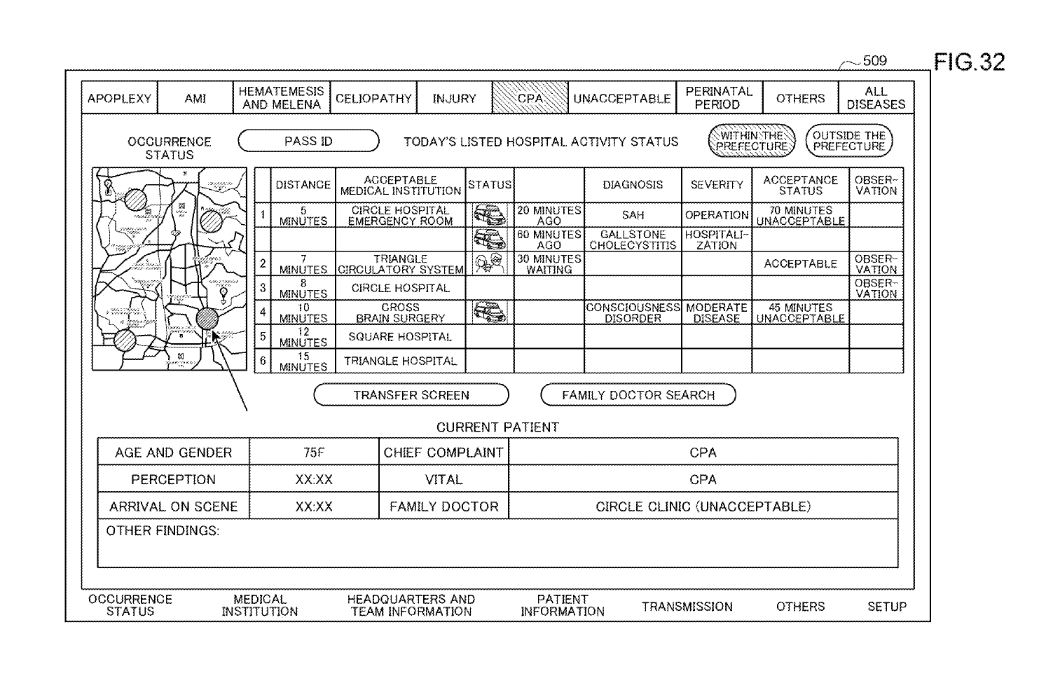

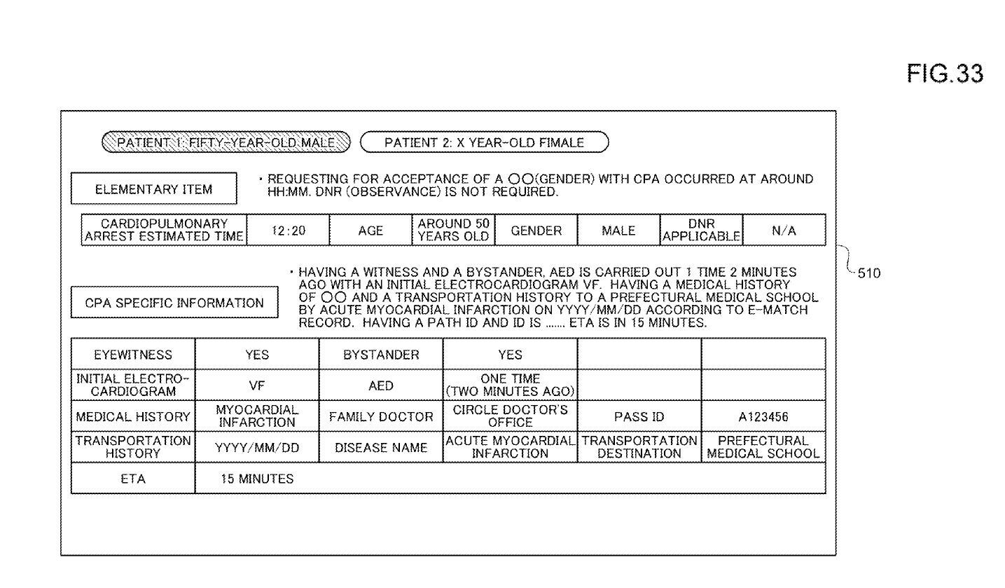

If one among endogenous adult CPA, endogenous infantile CPA, exogenous CPA, and DNR applicable CPA is selected in the input designation area for highly emergency diseases displayed on the left upper side in the initial branching screen 502, a screen is transited to an acceptance allowed/denied status screen 509 regarding CPA as shown in FIG. 32. With this screen 509, occurrence status (map), today's listed hospital activity status, current patient information are displayed. As the occurrence status, the scene and the neighbor hospitals are shown in the map. In the today's listed hospital activity status, acceptable medical institution name, distance to the medical institutions, status, diagnosis name, severity, acceptance status, etc. are displayed in a manner corresponding mutually. As the current patient, such as age, gender, chief complaint, perception, and scene arrival time are displayed. With this screen 509, if “transfer screen” button located at the center is tapped, a communication item panel 510 as shown in FIG. 33 is displayed. With the panel 510, as elementary items, cardiopulmonary arrest estimated time, age, gender, and DNR applicability are entered, and as CPA specific information, such as existence of eyewitness, existence of bystander, initial electrocardiogram, AED, medical history, family doctor, pass ID, transportation history, disease name, transportation destination, and ETA are entered.

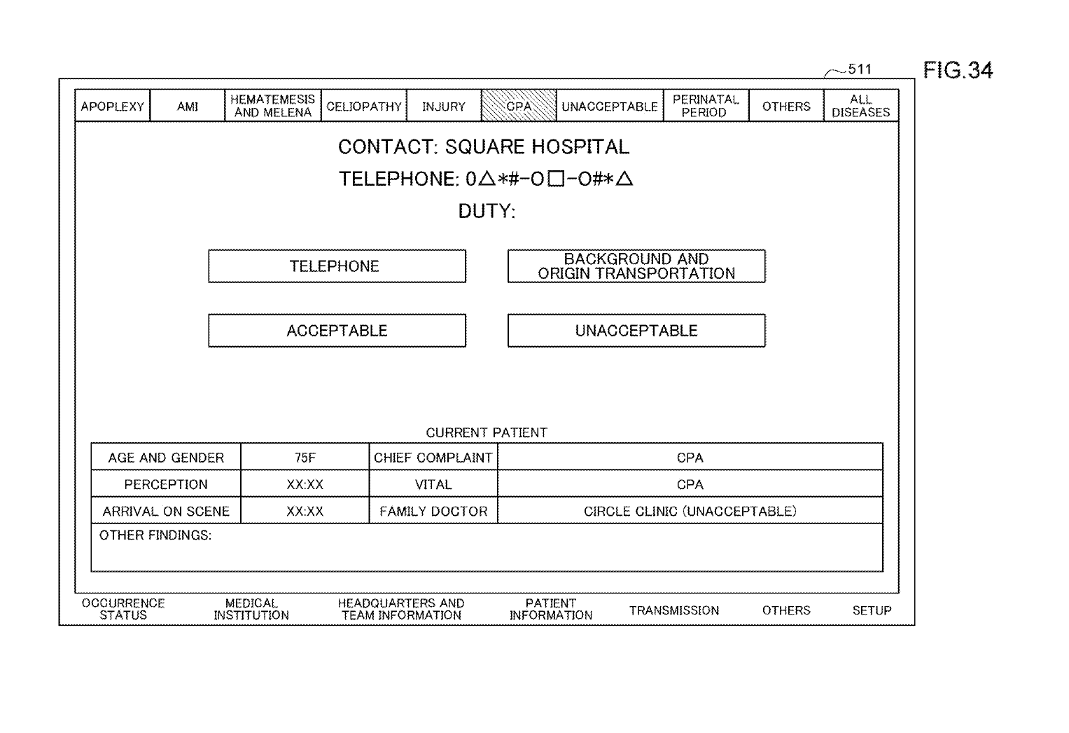

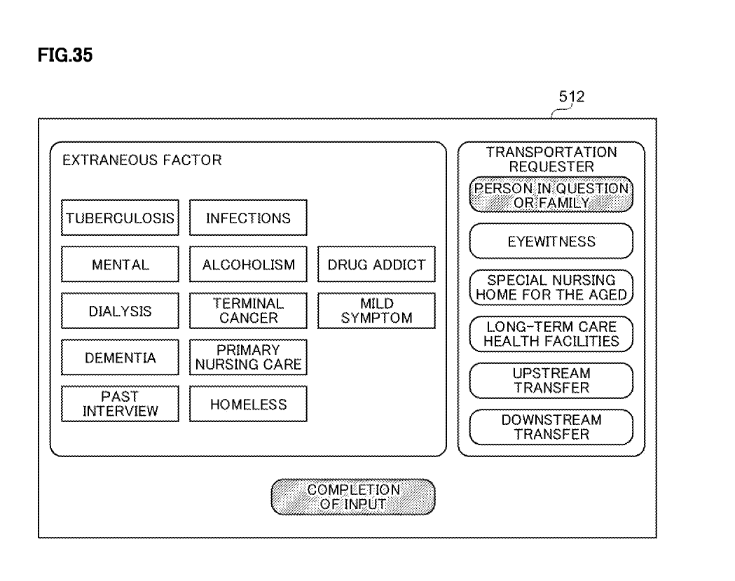

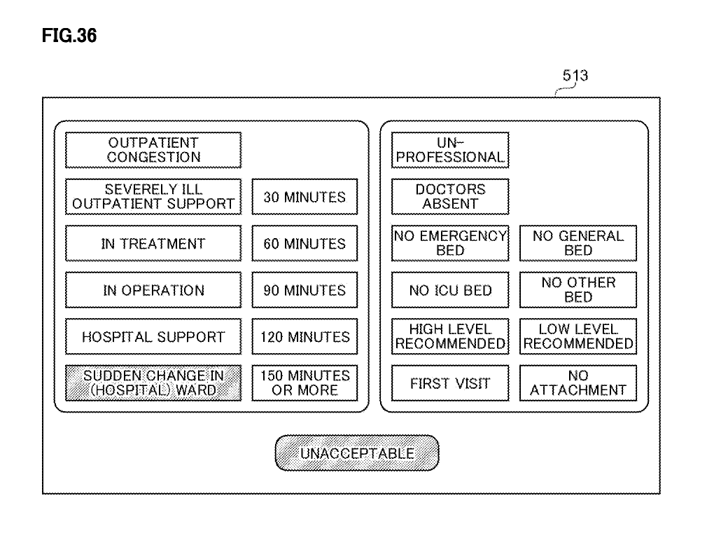

With the acceptance allowed/denied status screen 509, if a hospital is chosen from the list of the today's listed hospital activity status, a screen is transited to the acceptance allowed/denied input screen 511 as shown in FIG. 34. With the screen 511, displayed on an upper side are a medical institution to be contacted, a telephone number, and an on duty doctor's name, and in a middle section, buttons of telephone, background and transportation origin, acceptable, and unacceptable are displayed. When the telephone button is tapped, the communication item panel 510 described above is displayed. If the background and transportation origin button is tapped, a background and transportation origin input panel 512 as shown in FIG. 35 is displayed. With this panel 512, extraneous factor and transportation requester can be entered. The extraneous factor can be selected in a plural number, and any one of the transportation requesters is chosen. When the unacceptable button is tapped upon manipulation of the terminal at the medical institution or the like, an unacceptable reason input panel 513 as shown in FIG. 36 is displayed. With this panel 513, unacceptable reason can be selected.

As described above, the server according to the embodiment of the invention has a feature of the server 201, 202 communicable with the mobile device 200 through a network after a prescribed authentication, the server comprising: the main control unit 301a handling an entire control; the display control unit 301b producing screen data as to control a screen display on the mobile device 200; the time stamp acquisition unit 301c for detecting an event including dispatch, scene arrival, scene departure, onscene observatory finding, observatory finding during transportation, hospital arrival, and diagnosis, treatment, and outcome in hospital from the mobile device 200 and for acquiring a time stamp; the information registration unit 301d for receiving information registration; the listing unit or list production unit 301f for listing active status of the hospital based on the registered information; and the severity determination unit 301e for determining emergency degree and severity of illness or injury state based on at least the registered information and a performance standard on transportation and acceptance of a sick or injured person determined by each municipality.

The severity determination unit 301e renders the medical institutions (mainly emergency rescue centers) responsible to diseases of high emergency the transportation destination candidates based on the emergency degree specified by the algorisms, and selects the transportation destination candidates in considering the anticipated disease and its severity in addition to the emergency degree.

The system for assisting control of rescuing medical services according to the embodiment of the invention has a feature of the system for assisting control of rescuing medical services, comprising the mobile device 200, the server 201, 202 communicable with the mobile device 200 through the network, and the statistical server 204, wherein the server 201, 202 includes: a main control unit 301a handling an entire control; the display control unit 301b producing screen data as to control a screen display on the mobile device 200; the time stamp acquisition unit 301c for detecting an event including dispatch, scene arrival, scene departure, onscene observatory finding, observatory finding during transportation, hospital arrival, and diagnosis, treatment, and outcome in hospital from the mobile device 200 and for acquiring a time stamp; the information registration unit 301d for receiving information registration; the list production unit 301f for listing active status of the hospital based on the registered information; and the severity determination unit 301e for determining emergency degree and severity of illness or injury state based on the registered information and “practice standard of transportation and acceptance of diseased persons” determined by each municipality, wherein the statistical server 204 produces such as prescribed medical quality indexes (clinical indexes), daily reports, monthly reports, and displayed reports on the map automatically and periodically based on the acquitted time stamp and the registered information, and wherein the severity determination unit 301e of the server 201, 202 displays the transportation medical institution candidates corresponding to specific diseases as a list based on the emergency degree and severity and based on the transportation acceptable medical institution list determined by each municipality in a case that a specific disease is anticipated.

The various indexes relate to verification of transportation reference of the diseased persons and evaluation of acceptance reference of the medical institutions, and basic ones are pre-installed as contents, bur can be added or modified.

The mobile terminal can be a touch panel type terminal. The touch panel type terminal conceptionally includes terminals such as a tablet type PC and a smart phone as a matter of course.

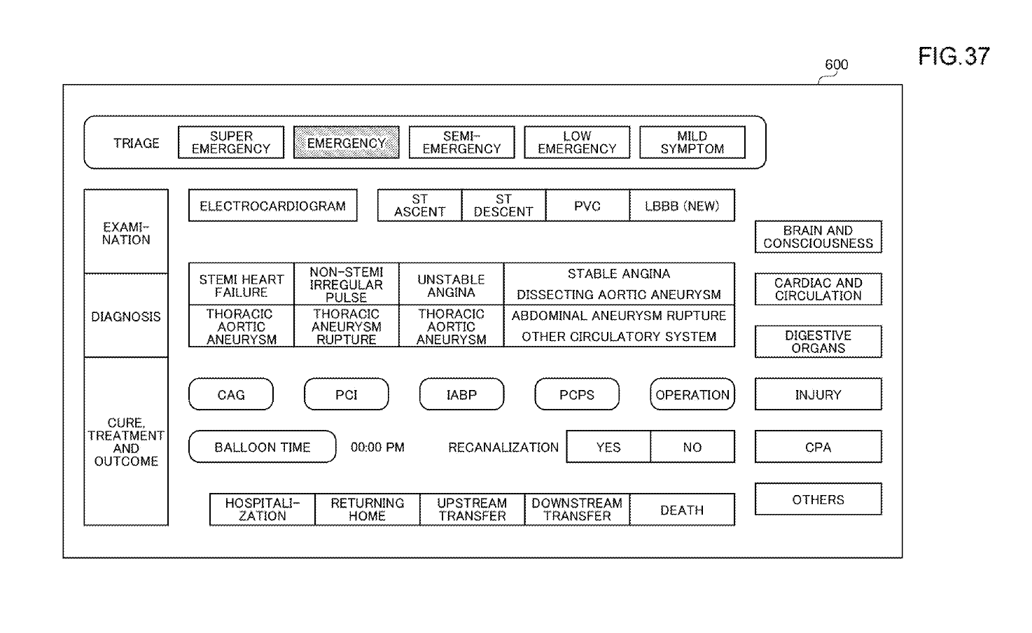

If the mobile terminal is on the side of the hospitals, the variety of medical information such as diagnosis results can be inputted from an input screen. FIG. 37 shows an example of a hospital side input screen 600. Herein, the input screen 600 for disease of “cardiac and circulation” is shown. As shown in FIG. 37, a patient's triage (deciding treatment priority) is selected on the side of the hospital. In this example, a doctor or the like of the accepting hospital selects one among “super emergency,” “emergency,” “semi-emergency,” “low emergency”, and “mild symptom.” Even though a patient is transported as emergency by the EMT at the time acceptance, his triage is reviewed at the selection time, and the patient groups waiting for the diagnosis on the side of the hospital are subject to renewal of the diagnosis sequence according to the selected triage. Subsequently, examination contents (e.g., electrocardiogram in this example), diagnosis contents (e.g., STEMI (ST accent type Myocardial Infarction), heart failure, irregular pulse, etc. in this example), cure and treatment contents (e.g., CAG (selective coronary angiography), PCI, etc.) are entered. For example, PCI means a coronary artery treatment using a catheter, and if the PCI is selected, related persons of other medical institutions generally come to recognize that the incident medical institution cannot conduct a treatment on other patients for a prescribed period. Subsequently, for example, “hospitalization,” “returning home,” “upstream transfer,” “downstream transfer,” and “death” are selected as outcome information. For example, if “hospitalization” is selected, a recognition that the medical institution becomes very busy for treatments for a prescribed period of time, e.g., one hour for that procedure is grasped by other related persons through external terminals. When such entries are made, the input information is not only recorded in the database of the data server 202 as medical information but also shared at the real time with plural medical institutions, EMTs, and other related persons. In addition to the input screen 600 regarding “cardiac and circulation” as input screens on the hospital side, respective input screens of “brain and consciousness,” “digestive organs,” “injury,” “CPA (cardio pulmonary arrest),” “other” can be selected, and prescribed medical information can be selectively entered for respective diseases.

As described above, the statistic server 204 automatically and periodically produces such as prescribed medical quality indexes (clinical indexes), daily reports, monthly reports, and displayed reports on the map based on the acquitted time stamp and the registered information. Hereinafter, an example of those is described.

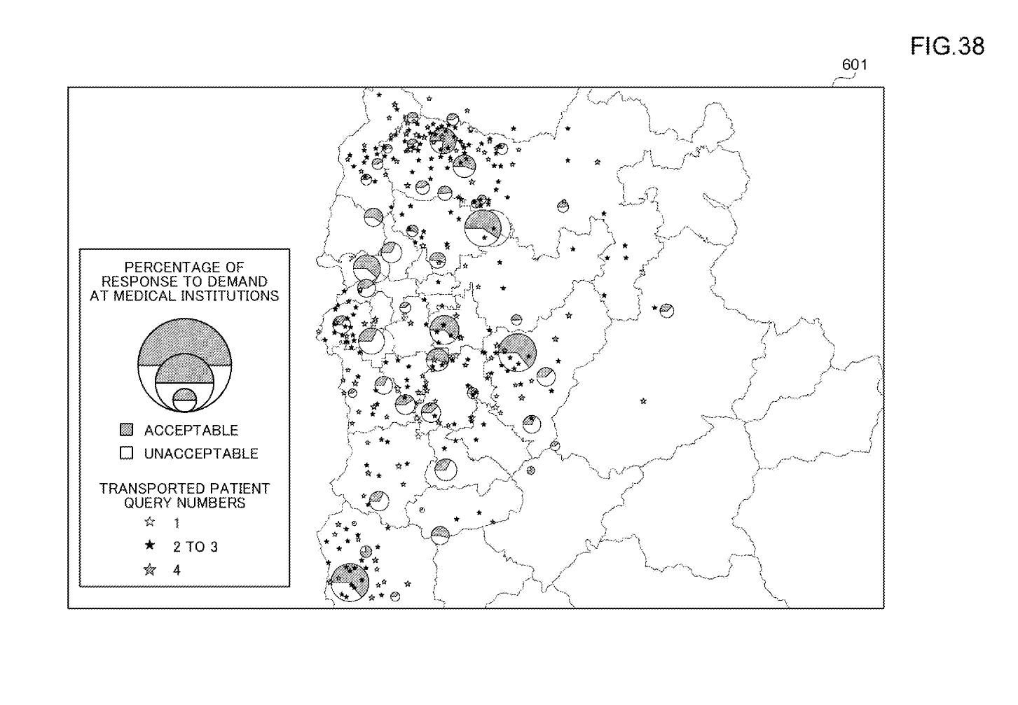

FIG. 38 shows a display screen 601 of a rescue patient occurrence map. In FIG. 38, the respective areas divided for respective cities, towns, and villages (city basis in this map) are colorized according to the response to demand rate in the administrated areas. At each area, the query number of the transported patients is shown with star marks, and the query number is recognized by its color. The position at which the star is plotted means the occurrence place of the patients. This position can be specified automatically from the GPS function of the terminal of the EMT. The response to demand rate of the medical institution is shown with circular graphs on the rescue patient occurrence map. The grayscale shows a rate of acceptance, and white shows a rate of not acceptance. The size of the circular graph reflects response to demand, or namely, frequency of calling for acceptance.

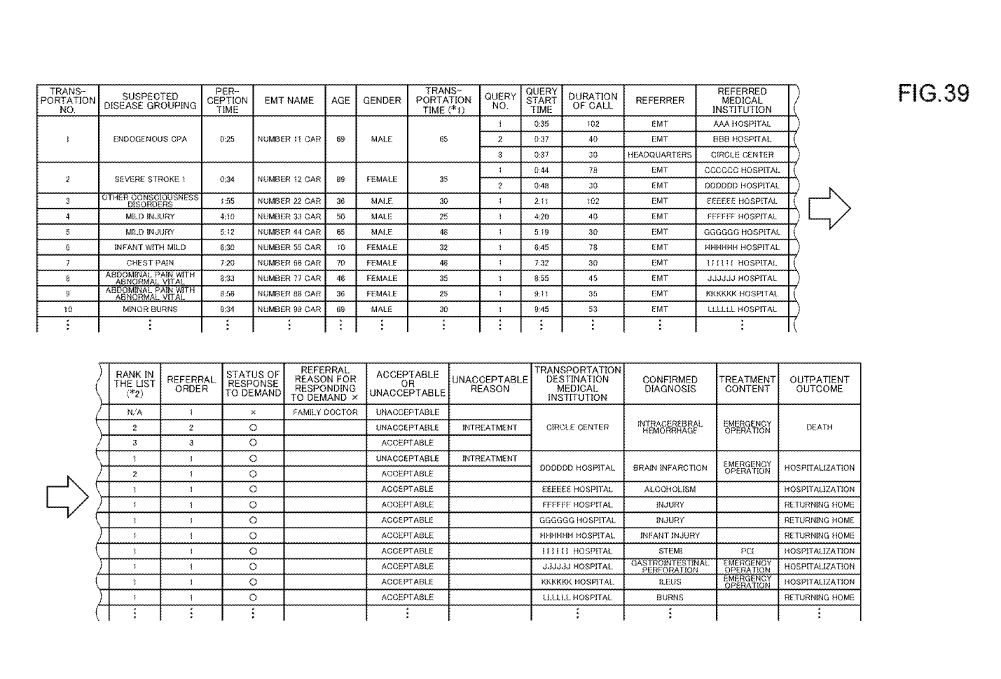

FIG. 39 shows an example of produced daily report of respective medical institutions. In FIG. 39, a transportation symptom list as the daily report for firefighting headquarters is shown. As shown in FIG. 39, with the transportation symptom list, indicated are: transportation no., suspected disease grouping, perception time, EMT name, age, gender, transportation time, query no., query start time, duration of call, referrer, referred medical institution, rank in the list, referral order, status of response to demand, referral reason for response to demand x, acceptable or unacceptable, unacceptable reason, transportation destination medical institution, confirmed diagnosis, treatment content, and outpatient outcome. Herein, the transportation time means a required time (unit: minute) from perception to transfer to the doctor.

Furthermore, a list of all of the patients referred to the own hospital can be produced with respect to the patient number of the suspected disease section basis. This is to show yesterday's referral number, acceptance number, response to demand rate, accumulation of this week (referral number, acceptance number, and response to demand rate), accumulation of this month (referral number, acceptance number, and response to demand rate), and accumulation of this year (referral number, acceptance number, and response to demand rate).

The system can produce a monthly report of respective medical institutions. This is for statistics for each medical institution, and a list of all of the patients referred to the own hospital can be produced as a monthly statistics. This is to show the statistics of every month (referred number up to the previous month, acceptance number, and response to demand rate), accumulation of this month (referral number, acceptance number, and response to demand rate), and accumulation of this year (referral number, acceptance number, and response to demand rate).

As the statistics for the entire prefecture, the whole statistics can be indicated. As the reporting contents, regarding “referral and transportation,” shown are: such as entire referral number, entire transportation number, response to demand rate, one time referral, one time referral rate, number of four times or more, referral rate of four times or more, entire transportation time (center value), entire transportation time (average), number of thirty munities or more, and referral rate of thirty munities or more. For “medical institutions,” apoplexy curing number, emergency CAG case number, emergency operation number, emergency hospitalization number can be indicated. As the statistics for respective diseases, shown are: such as transportation no., suspected disease class, perception time, EMT name, age, gender, entire transportation time, referral number, transportation destination medical institution, confirmed diagnosis, treatment content, and outpatient outcome. As suspected disease classes, shown are: endogenous CPA, exogenous CPA, infantile CPA, CPA others, severe apoplexy 1, severe apoplexy 2 to 4, severe apoplexy 5, apoplexy 2 to 3, apoplexy 2 to 3tPA, apoplexy 5, SAH4, other severe consciousness disorder, chest pain, abdominal pain accompanied with shock and consciousness disorder, abdominal pain accompanied with vital abnormality, severe abdominal pain, large volume hematemesis and melena, infantile severe disease (respiratory, convulsion, more forty degree, etc.), infantile mild disease, other severe endogenous disease, other mild endogenous disease, severe injury, mild injury, severe burn, and mild burn.

In this embodiment, the server 201, 202 includes the severity determination unit 301e for determining emergency degree and severity of illness or injury state based on at least the registered information and the practice standard of transportation and acceptance for diseased persons determined by each municipality, but the severity can be determined on the side of the mobile terminal 200 when the prescribed application is installed in the mobile terminal.

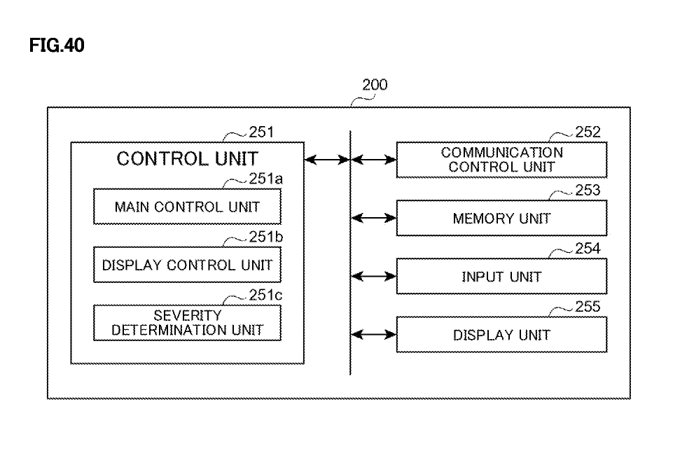

That is, in FIG. 40, a detailed structure of the mobile terminal 200 is shown. As shown in FIG. 40, the mobile terminal 200 includes a control unit 251, a communication control unit 252, a memory unit 253, an input unit 254, and a display unit 255. The control unit 251 functions, by executing the control program, a main control unit 251a, a display control unit 251b, and a severity determination unit 251c. The main control unit 251a handles the control of the entire body. The display control unit 251b controls the display. The severity determination unit 251c calculates patient's severity based on the registered information and the various indexes. For example, with the screen 502 as shown in FIG. 25, if such as consciousness status, blood pressure, pulse, respiratory, body temperature, and SpO2 are entered by the EMT, the severity determination unit 251c can determine the emergency degree of the disease based on the input information and display it on the screen.

Although the embodiment of the invention is described, this invention is not limited to that, and this invention can, as a matter of course, be improved or modified in various ways as far as not deviated from the subject matter of the invention. For example, pictures and movies regarding the observations on the scene or during the transportation are displayed in the screen, or voice can be outputted.

### DESCRIPTION OF REFERENCE NUMBERS

| 101a, 102, 103a | information terminal |
|---|---|
| 101b, 103b, 104, 105a~105c | tablet type terminal |
| 106 | Internet network |
| 200 | mobile terminal |
| 201 | www server |
| 202 | data server |
| 203 | data |
| 204 | statistics server |
| 300 | server |
| 301 | control unit |
| 301a | main control unit |
| 301b | display control unit |
| 301c | time stamp acquisition unit |
| 301d | information registration unit |
| 301e | severity determination unit |
| 301f | listing unit |
| 301g | index production unit |
| 302 | communication control unit |
| 303 | memory unit |

What is claimed is:

1. A server communicable with a mobile device through a network after a prescribed authentication, the server comprising:
a main control unit handling an entire control;
a display control unit producing screen data as to control a screen display on the mobile device;
a time stamp acquisition unit for detecting an event including dispatch, scene arrival, scene departure, onscene observatory finding, observatory finding during transportation, hospital arrival, and diagnosis, treatment, and outcome in hospital from the mobile device and for acquiring a time stamp;
an information registration unit for receiving information registration;
a list production unit for listing active status of the hospital based on the registered information; and
a severity determination unit for determining emergency degree and severity of illness or injury state based on at least the registered information and a performance standard on transportation and acceptance of a sick or injured person determined by each municipality.

2. The server according to claim 1, wherein the display control unit controls to display a list of possible transport destination medical institutions corresponding to a particular illness or injury state where the severity determination unit assumes a doubt on the respective corresponding medical institutions and the particular illness or injury state based on the emergency degree and severity of the illness or injury state and on a list of corresponding transport destination medical institutions determined by each municipality.

3. A system for assisting control of rescuing medical services, comprising a mobile device, an association server communicable with the mobile device through a network, and a statistical server,
wherein the association server includes:
a main control unit handling an entire control;
a display control unit producing screen data as to control a screen display on the mobile device;
a time stamp acquisition unit for detecting an event including dispatch, scene arrival, scene departure, onscene observatory finding, observatory finding during transportation, hospital arrival, and diagnosis, treatment, and outcome in hospital from the mobile device and for acquiring a time stamp;
an information registration unit for receiving information registration;
a list production unit for listing active status of the hospital based on the registered information; and
a severity/urgency determination unit for determining emergency degree and severity of illness or injury state based on at least the registered information and a prescribed standard determined by each municipality,
wherein the statistical server produces a prescribed report automatically and periodically based on the acquitted time stamp and the registered information, and
wherein the display control unit controls to display a list of possible transport destination medical institutions corresponding to a particular illness or injury state where the severity determination unit assumes a doubt on the respective corresponding medical institutions and the particular illness or injury state based on the emergency degree and severity of the illness or injury state and on a list of corresponding transport destination medical institutions determined by each municipality.

4. The system for assisting control of rescuing medical services according to claim 3, wherein the mobile device is a device having a touch panel.

5. The system for assisting control of rescuing medical services according to claim 3, wherein the prescribed standard determined by each municipality includes a performance standard on transportation and acceptance of a sick or injured person.

6. The system for assisting control of rescuing medical services according to claim 3, wherein the prescribed report includes a report in association at least with any one of a medical care quality index, a daily report, a monthly report, and an indication on a map.

7. A mobile device communicable with a server through a network after a prescribed authentication, comprising:
a main control unit handing an entire control;
a communication control unit for communications;
a display control unit for controlling display based on screen data;
an input unit for receiving an input of an event including dispatch, scene arrival, scene departure, onscene observatory finding, observatory finding during transportation, hospital arrival, and diagnosis, treatment, and outcome in hospital;
a severity/urgency determination unit for determining emergency degree and severity of illness or injury state based on at least the registered information and a performance standard on transportation and acceptance of a sick or injured person determined by each municipality; and
a display unit for making display,
wherein the display control unit controls the display unit to display a list of possible transport destination medical institutions corresponding to a particular illness or injury state where the severity determination unit assumes a doubt on the respective corresponding medical institutions and the particular illness or injury state based on the emergency degree and severity of the illness or injury state and on a list of corresponding transport destination medical institutions determined by each municipality.
